(19) United States
(12) Patent Application Publication
(10) Pub. No.: US 2023/0297677 A1
(43) Pub. Date: Sep. 21, 2023

(54) INFORMATION PROCESSING APPARATUS AND FUNCTION OPERATION CONTROL METHOD OF THE SAME

(71) Applicant: SHARP KABUSHIKI KAISHA, Sakai City (JP)

(72) Inventor: KENJI ITOH, Sakai City (JP)

(21) Appl. No.: 18/122,630

(22) Filed: Mar. 16, 2023

(30) Foreign Application Priority Data
Mar. 18, 2022 (JP) 2022-043943

(51) Int. Cl. G06F 21/56

(52) U.S. Cl. CPC G06F 21/568; G06F 21/561

(57) ABSTRACT

An information processing apparatus includes a virus detector, a virus information acquirer that acquires virus information that identifies a detected computer virus, a function execution availability determiner that determines functions to be permitted and functions to be prohibited using the acquired virus information, and a function operation setter that sets execution availability of the functions based on a result of the determination. The function operation setter sets functions determined to be permitted as execution permitted functions and functions determined to be prohibited as execution prohibited functions. The functions set as the execution prohibited functions by the function operation setter are prohibited until a state in which execution is to be permitted is entered and become executable after the state in which execution is to be permitted is entered.

### BACKGROUND OF THE INVENTION

### Field of the Invention

The present disclosure relates to an information processing apparatus, and in particular to an information processing apparatus that restricts executable functions when a computer virus is detected in the information processing apparatus, such as an image-forming apparatus having a large number of functions, and a function operation control method of the information processing apparatus.

### Description of the Background Art

In general, image-forming apparatuses (also referred to as multifunction peripherals) having a large number of functions, such as a printing function, a document reading function, a function of transmitting read image data, a fax transmission/reception function, an e-mail transmission/reception function, an image data acquisition function, and a character recognition function, have been used.

Such an image-forming apparatus having a large number of functions can be infected by computer viruses, as can personal computers and other electronic devices connected to a network.
Therefore, in order to cope with computer virus infection, some image-forming apparatuses have programs that execute a function of detecting a computer virus, a function of removing a computer virus, and the like.

For example, a network facsimile device is known that transmits, in a case where a computer virus is detected in a file attached to a received e-mail, a notification indicating that the computer virus has been detected to a PC, and adds a warning to a facsimile image in a superposed manner when an instruction for facsimile transmission is issued via a public line network and attaches text of a warning message to an e-mail or prohibit transmission via a LAN or a public network when an instruction for facsimile transmission is issued via the Internet.

Furthermore, for example, a computer system is known in which a computer, such as a POS terminal, acquires a list of processes that are actually running, generates a white list that includes names of the processes and corresponding executable file names, and causes a server to store the white list, the server distributes the white list to individual computer terminals, and each of the computer terminals acquires, when a process is generated, a name of the generated process and a corresponding executable file name, determines whether the acquired process name and the corresponding executable file name are included in the white list, and stops the generated process before generating a warning when the determination is negative.

As with general network facsimile devices, prohibition of transmission over LANs and public networks can prevent spread of computer virus infections.

However, in information processing apparatuses with a large number of functions, such as multifunction peripherals, when all the functions are stopped due to a detection of a computer virus, spread of computer virus infection can be prevented, but there arises a problem in that functions that are not directly related to the spread of infection and that do not cause the virus infection to spread even when the functions are activated are also disabled.

In addition, when an administrator is unable to immediately take measures, such as virus removal, after all the functions are stopped, functions that do not spread the infection when activated may remain unavailable for a long period of time in some cases, resulting in a problem of a lower operation rate of the apparatus and a problem that users may not use any of the functions.

Even after the detected computer virus is removed, it may be unclear whether a malfunction occurs when a function related to an infected program, etc., that has been stopped is restarted.

In addition, in the general computer systems, when a process that is not included in the white list is generated, the possibility of virus infection can be detected before the computer terminal fails by stopping activation of the process. However, even when a name of the generated process is included in the white list but a program itself of an executable file name corresponding to the name of the process has been already infected with a virus, continuation of the process may cause an error of the computer terminal, thereby spreading the virus infection.

Accordingly, the present disclosure has been made in consideration of the circumstances described above, and is intended to prevent the spread of computer virus infection by allowing execution of functions that are not affected by a detected computer virus after the detection of a computer virus in an information processing apparatus having many functions. At the same time, the present disclosure is provided to avoid a situation in which all the functions of the information processing apparatus may not be used, to suppress lowering of an operation rate of the information processing apparatus, and to ensure usability of the executable functions for users who use the information processing apparatus.

### SUMMARY OF THE INVENTION

According to an aspect of the present disclosure, an information processing apparatus includes a virus detector that detects a computer virus, a virus information acquirer that acquires virus information that identifies the detected computer virus, a function execution availability determiner that determines functions to be permitted and functions to be prohibited using the acquired virus information, a function operation setter that sets execution availability of the functions based on a result of the determination made by the function execution availability determiner, and a function executer that executes a selected one of the functions. The function operation setter sets functions determined to be permitted as execution permitted functions and functions determined to be prohibited as execution prohibited functions. The functions set as the execution prohibited functions by the function operation setter are prohibited from being executed by the function executer until a state in which execution is to be permitted is entered and become executable by the function executer after the state in which execution is to be permitted is entered.

The information processing apparatus may further include a virus remover that removes the detected computer virus. The functions to be permitted and the functions to be prohibited that are determined by the function execution availability determiner may differ between before and after removal of the detected computer virus. The number of functions to be permitted after the removal of the detected computer virus may be larger than the number of functions to be permitted before the removal.

The information processing apparatus may further include a virus remover that removes the detected computer virus. The state in which execution is to be permitted may be entered after the virus remover removes the detected computer virus.

The information processing apparatus may further include a virus remover that removes the detected computer virus, and a confirmation requester that requests confirmation that adverse effects of the removed computer virus are negligible from an administrator after the virus remover removes the detected computer virus. The state in which execution is to be permitted is entered after the administrator confirms that adverse effects of the removed computer virus are negligible.

The virus information acquirer may include a virus type determiner that determines a type of the detected computer virus, and an infection location identifier that identifies a location infected with the detected computer virus. The acquired virus information may include a type and an infection location of the detected computer virus.

The information processing apparatus may further include a storage that stores in advance function operation availability information including execution availability of the individual functions associated with types of computer virus and infection locations of the computer viruses. The function execution availability determiner may determine, using the function operation availability information, whether each of the functions is to be permitted or prohibited according to function execution availability associated with a type of the detected computer virus and a location infected with the detected computer virus.

The information processing apparatus may further include a display that displays a function selection screen including different selection display regions for different functions; and an operation acceptor that performs an input operation to select one of the selection display regions corresponding to a desired function to be executed. At least one of the selection display regions of a function set as an execution prohibited function by the function operation setter may be displayed on the function selection screen such that the selection display region is not selectable by the operation acceptor.

The information processing apparatus may be an image-forming apparatus having a plurality of functions.

A function operation control method of an information processing apparatus includes a controller that executes detecting a computer virus, acquiring virus information that identifies the detected computer virus, determining functions to be permitted and functions to be prohibited using the acquired virus information, and setting execution availability of the functions based on a result of the determination such that functions determined to be permitted as execution permitted functions and functions determined to be prohibited as execution prohibited functions. The functions set as the execution prohibited functions are prohibited until a state in which execution is to be permitted is entered and become executable after the state in which execution is to be permitted is entered.

In the function operation control method of an information processing apparatus, the acquiring virus information may include determining a type of the detected computer virus, and identifying a location infected with the detected computer virus. The acquired virus information may include the type and the infection location of the detected computer virus. In the determining functions to be permitted and functions to be prohibited, it may be determined, using function operation availability information in which execution availability of the individual functions are set in advance such that the execution availability is associated with a type of the detected computer virus and a location infected with the detected computer virus, whether each of the functions is to be permitted or to be prohibited in accordance with function execution availability associated with a type of the detected computer virus and a location infected with the detected computer virus.

According to an aspect of the present disclosure, an information processing apparatus includes a virus information acquirer that acquires virus information that identifies a detected computer virus, a function execution availability determiner that determines functions to be permitted and functions to be prohibited using the acquired virus information, and a function operation setter that sets execution availability of the functions based on a result of the determination made by the function execution availability determiner. The function operation setter sets functions determined to be permitted as execution permitted functions and functions determined to be prohibited as execution prohibited functions, and therefore, spread of infection of the computer virus is suppressed. Furthermore, a situation in which all the functions of the information processing apparatus may not be used when the information processing apparatus is infected with the computer virus is avoided, and degradation of an operation rate of the information processing apparatus is suppressed. Moreover, when a computer virus is detected, even before the computer virus is removed or when the removal is being executed, usability of executable functions for a user who uses the information processing apparatus may be ensured.

### BRIEF DESCRIPTION OF THE DRAWINGS

FIG. 1 is a block diagram illustrating a configuration of an image-forming apparatus according to an embodiment of the present disclosure.

FIG. 2 is an explanatory view of information stored in a storage of the image-forming apparatus according to the embodiment of the present disclosure.

FIG. 3 is an explanatory view of information stored in the storage of the image-forming apparatus according to the embodiment of the present disclosure.

FIG. 4 is an explanatory view of information stored in the storage of the image-forming apparatus according to the embodiment of the present disclosure.

FIG. 5 is an explanatory view of information stored in the storage of the image-forming apparatus according to the embodiment of the present disclosure.

FIG. 6 is an explanatory view of information stored in the storage of the image-forming apparatus according to the embodiment of the present disclosure.

FIG. 7 is an explanatory view of information stored in the storage of the image-forming apparatus according to the embodiment of the present disclosure.

FIG. 8 is an explanatory view of information stored in the storage of the image-forming apparatus according to the embodiment of the present disclosure.

FIG. 9 is an explanatory view of information stored in the storage of the image-forming apparatus according to the embodiment of the present disclosure.

FIG. 10 is an explanatory view of information stored in the storage of the image-forming apparatus according to the embodiment of the present disclosure.

FIG. 11 is an explanatory view of information stored in the storage of the image-forming apparatus according to the embodiment of the present disclosure.

FIG. 12 is an explanatory view of information stored in the storage of the image-forming apparatus according to the embodiment of the present disclosure.

FIG. 13 is an explanatory view of information stored in the storage of the image-forming apparatus according to the embodiment of the present disclosure.

FIG. 14 is a flowchart of virus detection and a function operation control process of the image-forming apparatus according to the embodiment of the present disclosure.

FIG. 15 is the flowchart of the example of the virus detection and the function operation control process of the image-forming apparatus according to the embodiment of the present disclosure.

FIG. 16 is the flowchart of the example of the virus detection and the function operation control process of the image-forming apparatus according to the embodiment of the present disclosure.

FIG. 17 is the flowchart of the example of the virus detection and the function operation control process of the image-forming apparatus according to the embodiment of the present disclosure.

FIG. 18 is a flowchart of an example of virus detection and a function operation control process of the image-forming apparatus according to the embodiment of the present disclosure.

FIG. 19 is an explanatory view of a screen displayed on a display of the image-forming apparatus according to the embodiment of the present disclosure.

FIG. 20 is an explanatory view of a screen displayed on the display of the image-forming apparatus according to the embodiment of the present disclosure.

FIG. 21 is an explanatory view of a screen displayed on the display of the image-forming apparatus according to the embodiment of the present disclosure.

FIG. 22 is an explanatory view of a screen displayed on the display of the image-forming apparatus according to the embodiment of the present disclosure.

FIG. 23 is an explanatory view of a screen displayed on the display of the image-forming apparatus according to the embodiment of the present disclosure.

FIG. 24 is an explanatory view of a screen displayed on the display of the image-forming apparatus according to the embodiment of the present disclosure.

FIG. 25 is an explanatory view of a screen displayed on the display of the image-forming apparatus according to the embodiment of the present disclosure.

FIG. 26 is an explanatory view of a screen displayed on the display of the image-forming apparatus according to the embodiment of the present disclosure.

FIG. 27 is an explanatory view of a screen displayed on the display of the image-forming apparatus according to the embodiment of the present disclosure.

FIG. 28 is an explanatory view of a screen displayed on the display of the image-forming apparatus according to the embodiment of the present disclosure.

FIG. 29 is an explanatory view of a screen displayed on the display of the image-forming apparatus according to the embodiment of the present disclosure.

### DESCRIPTION OF THE PREFERRED EMBODIMENTS

An embodiment of the present disclosure will be described hereinafter with reference to the accompanying drawings. Note that a description of the embodiment below does not limit the present disclosure.

The information processing apparatus of the present disclosure has a function of detecting a computer virus (hereinafter simply referred to as a “virus”) that invades through a network, a storage device, or the like, determining a type or the like of the detected virus, and isolating or removing the virus.

Alternatively, it is assumed that the information processing apparatus includes a dedicated antivirus program capable of detecting and removing viruses.

The following example describes an image-forming apparatus that is equivalent to the information processing apparatus and has a plurality of functions.

However, an information processing apparatus is not limited to an image-forming apparatus, but may be any electronic device having a large number of functions, such as a personal computer, a scanner, a display device, a recording device, or a robotic device.

Configuration of Image-Forming Apparatus

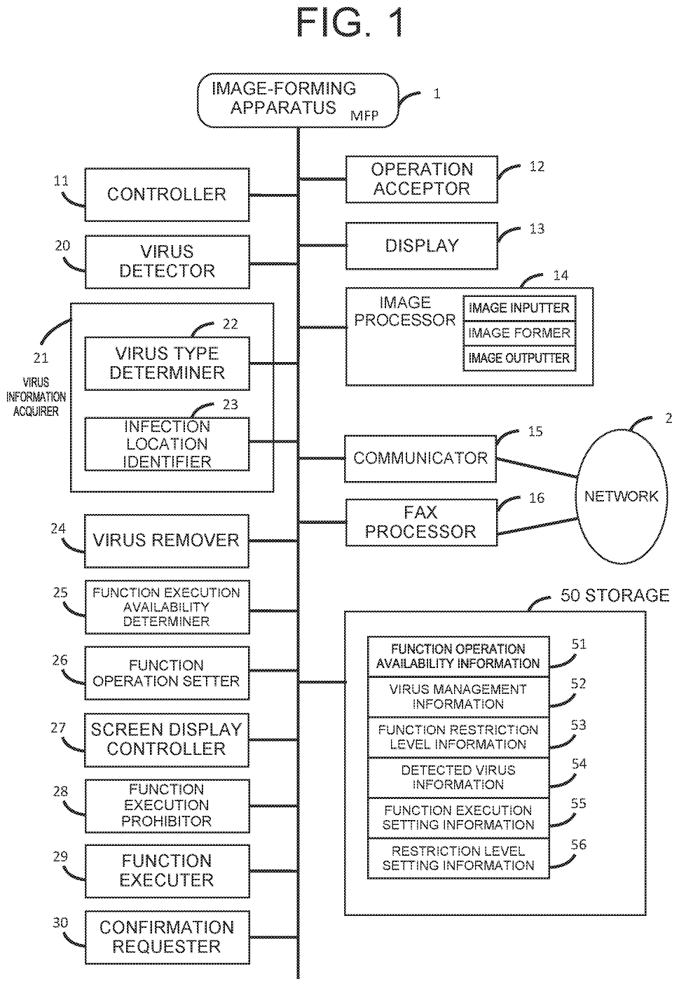

FIG. 1 is a block diagram illustrating a configuration of the image-forming apparatus according to an embodiment of the present disclosure.
The image-forming apparatus (MFP: Multifunction Peripheral) processes image data and mainly performs input, formation, output, storage, and transfer of image data.
An image-forming apparatus 1 is referred to as a multifunction peripheral, or simply, an MFP. The image-forming apparatus 1 is an electronic device having a function of processing image data, such as a copying (copy) function, a printing function, a document reading (scanning) function, a document editing function, a document saving function, a document transmission/reception (facsimile transmission/reception or scanner document transmission) function, an e-mail transmission/reception function, a file transfer function, and a communication function.

It is assumed, in the embodiment below, that the image-forming apparatus 1 according to the present disclosure has, among others, a copying function, a scanner function, a fax function, an e-mail function, a remote printing function, a file saving (document filing) function, and a file transfer (FTP) function, but may have other functions.

In FIG. 1, the image-forming apparatus (MFP) 1 of the present disclosure mainly includes a controller 11, an operation acceptor 12, a display 13, an image processor 14, a communicator 15, a fax processor 16, a virus detector 20, a virus information acquirer 21, a virus remover 24, a function execution availability determiner 25, a function operation setter 26, a screen display controller 27, a function execution prohibitor 28, a function executer 29, a confirmation requester 30, and a storage 50.

Here, the image processor 14 mainly includes an image inputter, an image former, and an image outputter as described below.
Furthermore, the virus information acquirer 21 includes a virus type determiner 22 and an infection location identifier 23.

The controller 11 controls operations of the individual components, such as the display 13 and the image processor 14, and is implemented by a microcomputer that mainly includes a central processing unit (CPU), a read-only memory (ROM), a random-access memory (RAM), an input/output (I/O) controller, and a timer.

The CPU organically activates various types of hardware based on control programs stored in a nonvolatile memory, such as the ROM, in advance and executes an image forming function, a virus detection function, and the like of the present disclosure.

Of the above components, the virus detector 20, the virus information acquirer 21 (the virus type determiner 22 and the infection location identifier 23), the virus remover 24, the function execution availability determiner 25, and the function operation setter 26 are functional blocks in which the CPU executes respective processes based on predetermined programs.

The operation acceptor 12 is an input device for the user of the image-forming apparatus 1 to perform predetermined input operations. For example, the operation acceptor 12 is a component for inputting information, such as characters, and selecting and inputting a function, and a keyboard, a mouse, a touch panel, and the like, are used as the operation acceptor 12.

Examples of keys operated by the user include an operation start key, a function selection key, and a setting key.
The user, for example, executes scanning of a document by operating the touch panel or inputting a key to start the scanning operation, or starts an operation to transmit information to a predetermined destination by inputting a key to start the transmission of information, such as image data.

The display 13 is a component for displaying information and displays information required for executing the various functions, results of execution of the functions, and the like for the user. For example, an LCD, an organic EL display, or the like is used, and when a touch panel is used as the operation acceptor 12, the display 13 and the touch panel are provided in a superposed manner.

For example, the display 13 uses characters, symbols, graphics, images, icons, animations, moving images, and the like, to display information required to set setting items to be used for printing and the like performed by the image-forming apparatus and required to execute document reading function and the like, a screen for selecting a function to be executed (function selection screen), a screen for operating a selected function, a screen associated with a detected virus, and the like screens.

In the present disclosure, a function selection screen including selection display regions for the individual functions is displayed on the display 13.

In order to execute a desired function, the user performs an input operation to select one of the selection display regions corresponding to the desired function using the operation acceptor 12.

In this function selection screen, executable functions and inexecutable functions are displayed in a distinguishable manner.

For example, the selection display region of a function set as an execution prohibition function by the function operation setter 26, as described below, may be displayed in the function selection screen so that the function is not selectable by the operation acceptor 12. Furthermore, screens showing a virus infection state and a virus removal state, such as virus detection, removal in progress, and completion of removal, are displayed on the display 13.

The image processor 14 that executes an image-forming function, which is a main function of the image-forming apparatus 1, mainly includes an image inputter, an image former, and an image outputter.

Primarily, the image inputter inputs predetermined image data, the image former converts input image data into information that may be printed and the like, and the image outputter outputs the formed print information and the like onto print paper, etc.

The image inputter inputs image data of a document including images, characters, graphics, or the like, such as print data to be printed, and for example, reads a document placed on a document table or the like.

A scanner (reading device) that reads the document including information described thereon is used as the image inputter.
In order to read the document, the image-forming apparatus 1 includes a document placement table (the document table) on which a document is placed and a document cover that presses the document.
The image-forming apparatus 1 may further include an automatic document feeder (ADF) that receives a plurality of documents placed thereon and reads the documents while automatically conveying the documents one by one.

There are various methods for inputting image information, and a document including an image or the like is scanned by a scanner so that image data of the document (hereinafter referred to as input document data) is stored in the storage 50, for example.

In addition, an interface that connects an external storage medium, such as a USB flash drive, corresponds to the image inputter, for example.

An electronic data file of image information to be input, and the like, may be stored in an external storage medium, such as a USB flash drive, the USB flash drive or the like may be coupled to an input interface, such as a USB terminal, and a predetermined input operation may be performed by the operation acceptor 12, so as to read a desired electronic data file stored in the USB flash drive or the like and store the electronic data file as input image data in the storage 50.

For example, when printing print data on a recording medium, the image former generally performs steps for charging, exposing, developing, transferring, cleaning, static eliminating, and fusing in a continuous manner to form the print data on the recording medium.

In the developing step, toner is supplied from a toner cartridge to a developing device, and an electrostatic latent image formed on a surface of a charged photoreceptor drum is developed to form a toner image corresponding to the electrostatic latent image. The toner image formed on the surface of the photoreceptor drum is transferred onto a recording medium by a transfer device and then heated by a fusing device to be fused to the recording medium. The image former converts the input image data into information in a transferable and displayable form.

The image outputter outputs the formed input image data and corresponds to a printer, for example.

Note that the output of input image data includes not only printing but also storage of input image data of a scanned document and fax transmission of input image data of a scanned document.
For example, storage of input image data obtained by reading a document in an external storage medium, such as a USB flash drive, transmission of input image data to another information processing apparatus or a server via a network, such as the Internet, and classification and save of input image data into a specific save folder (document filing) also correspond to the output of an image.

The communicator 15 is used for data communication with another communication device through the network 2.

As the network 2, any existing communication line, such as a WAN including the Internet, a LAN, a telephone line, or a dedicated line, may be used.
As a form of connection with the network 2, any existing communication form may be used, and any of wired and wireless communication methods may be used.

For example, the image-forming apparatus (MFP) 1 is connected via the network 2 to a management server that stores information about viruses, and performs data communication with the management server to obtain information about existing viruses from the management server.

Alternatively, the image-forming apparatus 1 is connected to a predetermined mail server to receive e-mail messages stored in the mail server or to transmit e-mail messages to the mail server.

In addition, the image-forming apparatus 1 of the present disclosure uses the communicator 15 to transmit, to a terminal device of the administrator, information indicating that a virus has been detected, information about the detected virus, information about a current infection state, information indicating that the virus is not removable, information indicating that the virus has been removed, information requesting confirmation of permission to restart a function that had been stopped, and the like.

The fax processor 16 executes the facsimile function via the network 2.

For example, the fax processor 16 is connected to a specified facsimile communication device via a telephone line or the Internet, and transmits information on an image or the like converted into data in a format that can be transmitted by facsimile communication to the facsimile communication device.
Alternatively, the fax processor 16 responds to incoming calls from the facsimile communication device via a telephone line or the Internet, and receives images and other information transmitted by the facsimile communication device.

The virus detector 20 detects viruses that have invaded the image-forming apparatus. For example, when receiving an e-mail or an image data file to be printed, the virus detector 20 executes a prescribed virus detection process for the received e-mail or the like. As the virus detection process, a detection process generally used is performed, and for example, it is determined, when a file attached to an e-mail includes a pattern unique to a known virus, that the known virus is included in the e-mail.

The virus information acquirer 21 acquires information that identifies the detected virus (referred to as virus information).

The virus information to be acquired includes, for example, a type of detected computer virus and a location infected by the detected computer virus.
The type of detected computer virus is information determined by the virus type determiner 22 described below, and is hereinafter referred to as a virus type.
The location infected by the detected computer virus is information specified by the infection location identifier 23 described below, and is hereinafter referred to as an infection location. Note that, in the following embodiment, it is explained that at least the virus type and the infection location are obtained as virus information, but the information identifying the detected virus is not limited to these.

The virus type determiner 22 determines the type of detected virus or the like. As described above, when the virus detected by the virus detector 20 is a known virus, a name and a type of the virus are determined.

For example, virus management information 52 described below may be stored in advance, and the virus management information 52 may be used to determine a name of the virus, a type of the virus, and whether the virus can be removed associated with a pattern of the known virus.

Alternatively, an inquiry about a name and a type of the virus corresponding to the pattern of the detected virus may be issued via a network to the server that manages the information about viruses so that a virus name and a virus type corresponding to the pattern of the detected virus are acquired.

The virus type is a name by which viruses are classified according to their behavior and characteristics.

For example, viruses are generally classified into several types depending on whether the viruses can self-propagate, operate independently, or exist as parasites on other programs, etc. In the following embodiment of the present disclosure, viruses are mainly classified into four types. However, the types are not limited to these four types.

1. Macro Type (Macro Infection Type)

Programs that have a so-called macro function are infected with macro-type viruses, and such a virus infiltrates by parasitizing a file that can be executed by the program. When the file includes a macro-type virus, the virus is activated when an operation of opening the file is performed and unauthorized processing is performed.

2. File Type (File Infection Type)

File-type viruses are parasitic on an executable program boot file or invade as a program executable file. When an operation of executing the file is performed, a stored normal file is infected and unauthorized processing on the file, such as deleting, changing, or rewriting, is performed.

3. Trojan Type (Trojan Horse Type)

Trojan-type viruses that are referred to as Trojan horses do not propagate themselves, but can operate independently. For example, when such a virus invades as an attachment to an e-mail that is seen to be a non-malicious program, the virus exists unnoticed at a time of entry and then attempts to destroy programs or download unauthorized programs.

4. Worm Type

Worm-type viruses are capable of self-propagating and operating independently, and have a function of spreading and giving infection to other information processing apparatuses connected to the same network, for example.

As described above, the determined type of virus is used to determine executable functions and prohibited functions as described below.

The infection location identifier 23 identifies a location infected with the detected virus, an infection route, and the like, and identifies, for example, an infected program, an infected file, an infected function, and an infected storage medium.

For example, when a virus is detected in a file attached to an incoming e-mail, it is determined that an infection location is the e-mail or a network.
When a virus is detected in a USB flash drive connected to the image-forming apparatus, it is determined that an infection location is the USB flash drive (a portable storage memory). Alternatively, when a virus is detected in a storage device incorporated in the image-forming apparatus, such as a hard disk or an SSD, which corresponds to the storage 50 of the image-forming apparatus, it is determined that an infection location is the storage device, such as the internal hard disk.

In the following embodiment, it is assumed that there are three types of infection locations, that is, a network, a USB flash drive, and an internal hard disk.

As described above, the identified infection location is used to determine executable functions and prohibited functions as described below.

The virus remover 24 removes a detected virus.

When the type of the detected virus and the infection location, such as an infected file, are identified and the detected virus is removable, the detected virus itself is deleted using a virus removal program or the like.
Alternatively, deletion or quarantine of the file infected with the virus, deletion, stop of activation, or recovery of a program associated with the infection location may be performed.

The function execution availability determiner 25 uses the virus information acquired by the virus information acquirer 21 described above to determine functions to be permitted and functions to be prohibited for the large number of functions of the image-forming apparatus individually.

In other words, when a virus is detected, execution availability of each of the functions is determined based on information about the detected virus, an infection state, whether the virus has been removed, or the like.

For example, the execution availability is determined by using function operation availability information in which execution availability of each of the functions is set in association with a type of the detected virus and an infection location. That is, it is determined whether each of the functions is to be permitted or to be prohibited for each function depending on the execution availability of the functions associated with the type of the detected virus and the infection location of the detected virus that are set in the function operation availability information.

For example, when “execution permission” is set for the copying function in the function operation availability information, it is determined that the user may select the copying function on the function selection screen and perform a copy operation (execution permission).

On the other hand, when “execution prohibition” is set for the e-mail function in the function operation availability information, it is determined that the user may not select the e-mail function on the function selection screen or may not transmit or receive an e-mail (execution prohibition).
The function operation availability information is stored in advance in the storage 50, as described below, and examples of the details of the information will be described below.

In addition, the functions or the like affected by the detected virus are seen to be considerably different between before and after the detected virus is removed. After the detected virus has been removed, fewer or none of the functions are affected by the virus, and therefore, the possibility of generation of problems, such as spread of infection, is reduced even when most of the functions is permitted to be executed.

In other words, the functions to be permitted and the functions to be prohibited that are determined by the function execution availability determiner 25 are different before and after the detected virus is removed. The number of functions to be permitted after the detected virus is removed may be larger than the number of functions to be permitted before the detected virus is removed.

The function operation availability information described below shows an example of information in which availability settings for the individual functions are differentiated among before virus removal, during removal, and after completion of removal.

Thus, by permitting the execution of functions that are prohibited before the removal and increasing the number of functions to be permitted after the removal of the detected virus, an operation rate of the image-forming apparatus may be improved and a situation in which the user may not use the prohibited functions even though the user desires to use may be avoided. Accordingly, usability is ensured for the user.

The function operation setter 26 sets execution availability of each of the functions based on a result of the determination made by the function execution availability determiner 25.

The functions that are determined to be permitted based on the result of the determination made by the function execution availability determiner 25 described above are set as execution permitted functions that may be executed.
On the other hand, functions that are determined to be prohibited are set as execution prohibited functions that may not be executed.
It is assumed that the execution availability of each of the functions is set in function execution setting information 55 described below, and information indicating “execution permission” is set in a field of “execution availability” in the function execution setting information 55 for the execution permitted functions, and information indicating “execution prohibition” is set for the execution prohibited functions.

It is further assumed that a user may select a function that is set as the execution permitted function on a predetermined function selection screen, and when the function is selected by the user, the function is executed by the function executer 29.

On the other hand, it is assumed that a function that is set as the execution prohibited function by the function operation setter 26 is not to be executed, and the user may not select the function on the function selection screen.

However, the function set as the execution prohibited function is prohibited from being executed by the function executer 29 until a state in which execution is to be permitted is entered, and becomes executable by the function executer 29 after the state in which execution is to be permitted is entered.

The state in which execution is to be permitted is entered, for example, after the detected virus is removed by the virus remover 24.

After the detected virus is removed, the execution of the prohibited function may be permitted because, in principle, the virus is no longer likely to cause problems in the operation of the image-forming apparatus and there is no longer a risk of the infection spread by the virus.

However, for a higher level of security against viruses, after the detected computer virus is removed by the virus remover 24, a request for confirming that there is no adverse effect of the removed virus may be issued to the administrator of the image-forming apparatus.

In this case, the state in which execution is to be permitted is entered after the administrator confirms that there is no adverse effect of the removed virus.
Even after the detected virus is removed, for example, when an infected program or an infected file has been modified by the virus, the functions of the image-forming apparatus may not be performed properly, and the adverse effects of the removed virus may remain. Therefore, in such a case, it is preferable that the administrator confirms that the image-forming apparatus is actually operating properly and that there is no adverse effect of the removed virus.

The screen display controller 27 switches a screen displayed on the display 13 in response to a virus detection state and a virus removal state.

The screen display controller 27 mainly generates screens showing the virus detection and the removal state and the function selection screen, and displays one of the screens that corresponds to a current state on the display 13.
In particular, the function selection screen displays currently executable functions in a selectable manner, but functions that are prohibited from being executed may be displayed in a non-selectable manner.
By displaying the execution available functions and the execution prohibited function in a distinguishable manner, the user may easily recognize currently available functions and currently unavailable functions.
Alternatively, to avoid an error of selection operation, only the currently executable functions may be displayed, and the execution prohibited functions may not be displayed.

The function execution prohibitor 28 prohibits execution of a given function, and when the given function is currently being executed, stops the execution of the function. For example, the function execution prohibitor 28 prohibits or stops execution of functions corresponding to information indicating execution prohibition in the function execution setting information 55.

The function executer 29 executes a predetermined function selected by the user of the image-forming apparatus.

For example, the function executer 29 executes a function F when the user selects the function F in which information indicating that execution is available is set in the function execution setting information 55.

The confirmation requester 30 requests, after the virus detected by the virus remover 24 described above is removed, the administrator of the image-forming apparatus to confirm that there is no adverse effect of the removed virus or to confirm an operation state of the image-forming apparatus.

In general, after the detected virus is removed, the same problems as those in the virus-infected state may not occur, even when the prohibited functions are executed. However, in the case of a Trojan-type virus or a new type of virus, it may be better to have the administrator of the image-forming apparatus confirm that the virus has been completely removed for safety reasons, that there are no problems in resuming the prohibited functions, and that operations of the other functions have not been affected.

For example, it may be better that the administrator of the image-forming apparatus comes to a location where the apparatus is installed and checks its operation according to predetermined standards, or confirms that the virus has been completely removed by using a predetermined inspection tool or other means.

Therefore, confirmation request information indicating an infection state of the image-forming apparatus, completion of the removal of the detected virus, and a request of confirmation of the state of the image-forming apparatus is generated, and the confirmation request information is transmitted to a mobile terminal or the like owned by the administrator. Furthermore, in a case where the administrator is always stationed at the location where the image-forming apparatus is installed, the confirmation request information may be displayed on the display 13 of the image-forming apparatus or content of the confirmation request information may be reported by voice.

Alternatively, in the event of a virus infection, an LED or a similar device may blink to indicate that a virus infection has occurred, or a voice may be used to inform users and others in the vicinity of the image-forming apparatus that a virus infection has occurred, that certain functions may not be used, or that the displayed content is to be informed for the administrator by voice.

When the mobile terminal of the administrator receives the confirmation request information, the administrator may go to the installation site of the image-forming apparatus and perform the confirmation operation as described above.

After the confirmation operation is completed, when the administrator determines that the prohibited functions may be resumed, the functions may be resumed by performing a predetermined input operation implying function execution permission using the operation acceptor 12 of the image-forming apparatus.

However, when the administrator is unable to immediately go to the installation site of the image-forming apparatus, or when the administrator may determine that the prohibited functions may be resumed without going to the installation site, after checking the content of the received confirmation request information, a confirmation response indicating permission to execute all the functions may be transmitted from the mobile terminal to the image-forming apparatus, for example.

By enabling the image-forming apparatus that receives the confirmation response indicating the permission to execute all the functions to automatically execute all the functions, the execution prohibition can be quickly canceled, thereby improving an operation rate of the image-forming apparatus and ensuring usability for a user.

The storage 50 stores information and programs required for executing the individual functions of the image-forming apparatus MFP according to the present disclosure, and a semiconductor storage device, such as a ROM, a RAM, or a flash memory, a storage device, such as an HDD or an SSD, and other storage media are used.

For example, function operation availability information 51, virus management information 52, function restriction level information 53, detected virus information 54, function execution setting information 55, restriction level setting information 56, and the like are stored in the storage 50.

The function operation availability information 51 includes information indicating whether each of the functions of the image-forming apparatus is to be executable (execution availability) in accordance with a state after a detection of a virus if any and is preferably stored in the storage 50 in advance.

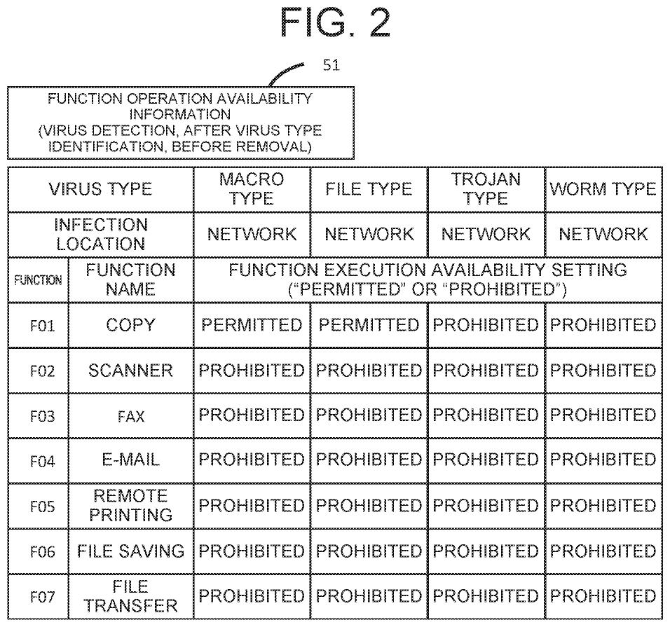

However, the administrator of the image-forming apparatus may change the execution availability for each function as needed.
Specific examples of the function operation availability information 51 are described below in FIGS. 2 to 9.

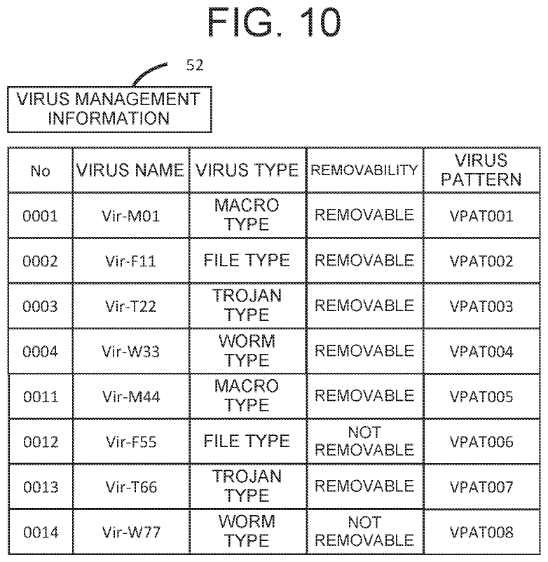

The virus management information 52 is information on known viruses and is stored in advance in the storage 50. FIG. 10 is a diagram illustrating an example of the virus management information 52.

The virus management information 52 in FIG. 10, for example, stores four items (a virus name, a virus type, removability, and a virus pattern) associated with one another for each of the plurality of known viruses.
The items stored to identify a virus are not limited to the four items shown in FIG. 10, but may include, for example, a time of occurrence, a region of occurrence, infectivity, self-concealing ability, and a destructive power.

As for “removability”, “not removable” is set when a virus has just been generated and there is no removal tool yet, but “removable” is set when a removal tool is obtained. The virus pattern is information mainly used to detect a virus, and is acquired from a server or other sources that stores information about viruses.

For example, a file stored in the image-forming apparatus, a file input or received for printing, or a file received as an attachment to an e-mail is compared with virus patterns in the virus management information 52, and a file with a pattern that matches a specific virus pattern is determined to be infected with a virus having the virus pattern.

The virus management information 52 in FIG. 10 shows information about eight known viruses.

For example, the first virus has a virus name of Vir-M01, a virus type of macro type, removability of “removable”, and a virus pattern named “VPAT001”.
However, since new viruses occur all the time, it is preferable to periodically acquire latest information from a server or other source that manages information about viruses, and update the virus management information 52 using the acquired information.

The function restriction level information 53 presets a level of restriction of a function to be performed after the detected virus is removed.

For example, three levels (high, medium, and low) are set in advance as levels to restrict functions to be performed, and information corresponding to each level is also set. The function restriction level information 53 may be set by the administrator of the image-forming apparatus, for example.
However, the function restriction level information 53 and the restriction level setting information 56 described below may not be set, and when these information items are not set, the “medium” level is regarded to be set in advance.

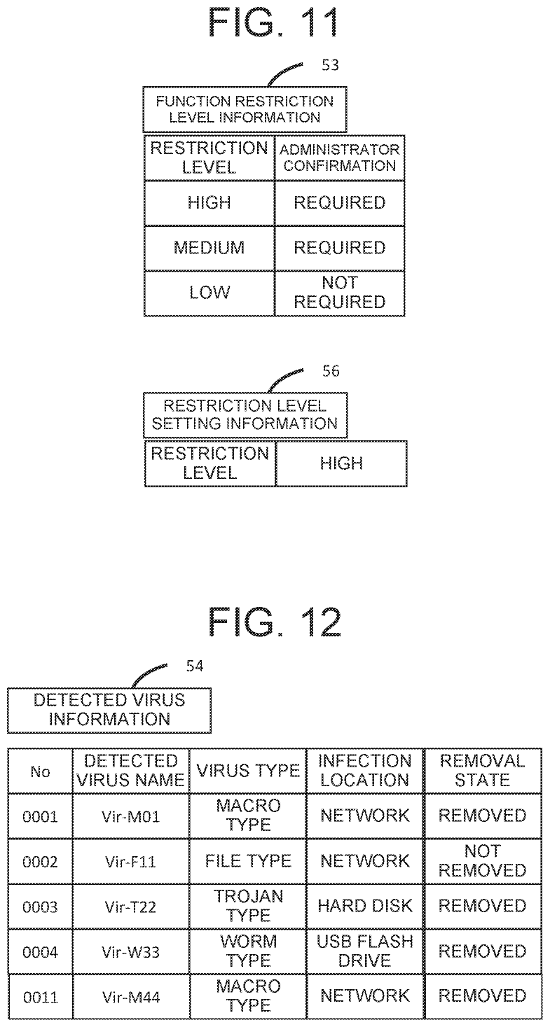

FIG. 11 is an explanatory diagram illustrating the function restriction level information 53 according to the embodiment.

In the function restriction level information 53 in FIG. 11, the three restriction levels are associated with information indicating whether administrator confirmation is required.

It is assumed that the three restriction levels of “high”, “medium”, and “low” are to be set, but the restriction levels are not limited to these three levels.

The information of “administrator confirmation” means that a confirmation as to whether execution of a prohibited function may be permitted is issued to the administrator.

The restriction level of “high” is the highest security level, and when this state is set, the security level remains sufficiently high to prohibit execution of a large number of functions even after a virus is removed, and furthermore, “required” is set in corresponding “administrator confirmation”.

When “required” is set for “administrator confirmation”, the confirmation requester 30 described above transmits confirmation request information to the mobile terminal of the administrator.
When information indicating permission to execute all the functions is returned from the administrator as a response to the confirmation request, execution of all the functions is permitted, including the prohibited functions.

The restriction level of “medium” indicates a state in which the security level is slightly lower than that of the restriction level of “high”, and when this state is set, execution of a comparatively large number of functions is prohibited in order to maintain the high security level even after a virus is removed, and furthermore, “required” is set in corresponding “administrator confirmation”.

In the case of the restriction level of “medium”, the confirmation request information is transmitted to the mobile terminal of the administrator in the same way as in the case of the restriction level of “high”.

The restriction level of “low” is a lowest security level, and when this state is set, all the functions are permitted to be executed in principle without requesting confirmation to the administrator after a virus is removed, and “not required” is set in corresponding “administrator confirmation”.

When “not required” is set for “administrator confirmation”, the confirmation requester 30 described above does not transmit confirmation request information to the mobile terminal of the administrator.
Therefore, when the restriction level of “low” is set, execution of all the functions of the image-forming apparatus is permitted immediately after a virus is removed, without waiting for a confirmation response or an input operation performed by the administrator.
In other words, when the restriction level of “low” is set, all the functions can be performed without waiting for a confirmation response by the administrator, thus improving the operation rate of the image-forming apparatus.

The detected virus information 54 stores information about viruses actually detected by the virus detector 20 described above.

FIG. 12 is an explanatory diagram of the detected virus information 54 according to the embodiment.
The detected virus information 54 in FIG. 12 includes a detected virus name, a virus type, an infection location, and a removal state.
However, not only these information items, other information, such as an infection time and a user name may also be included, and when a result of removal of a detected virus is not required to be stored as history, the removal state may not be included.

The detected virus name and the virus type are information acquired by the virus type determiner 22, and the infection location is information acquired by the infection location identifier 23.

The removal state is information that indicates whether removal of a virus is currently completed. For example, “No: not removed” is set before the virus removal, and “Yes: removed” is set when the virus removal is completed.
For example, a first virus in the detected virus information 54 in FIG. 12 has the detected virus name of Vir-M01, the virus type of a macro type, the infection location indicating invasion from a network, and the removal state indicating completion of removal.

The function execution setting information 55 stores current execution availability for each of the functions of the image-forming apparatus.

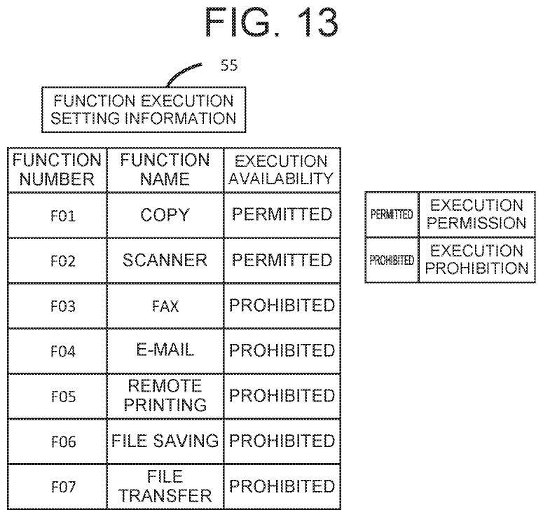

FIG. 13 is an explanatory diagram illustrating the function execution setting information 55 according to the embodiment.
The function execution setting information 55 in FIG. 13 includes a function number, a function name, and execution availability.
The function execution setting information 55 is set by the function operation setter 26 based on a result of a determination performed by the function execution availability determiner 25, and uses the function operation availability information 51 described above to set execution permission or execution prohibition for each function based on content of the execution availability of the function operation availability information 51 that corresponds to a virus type and an infection location of the detected virus.

In the function execution setting information 55 shown in FIG. 13 stores that, in a current situation, the copying function and the scanner function are permitted to be executed, while the other functions, such as the fax function, with function numbers F03 through F07 are prohibited from being executed.

By referring to the function execution setting information 55, the functions corresponding to “execution permission” set thereto are executed by the function executer 29, and the functions corresponding to “execution prohibition” set thereto are prohibited by the function execution prohibitor 28 and are stopped when being executed.

The restriction level setting information 56 stores restriction levels set and input by the administrator of the image-forming apparatus in the function restriction level information 53.

FIG. 11 also shows an example of the restriction level setting information 56, along with the function restriction level information 53 described above.
The restriction level setting information 56 in FIG. 11 shows a case where “high” is set as the restriction level.

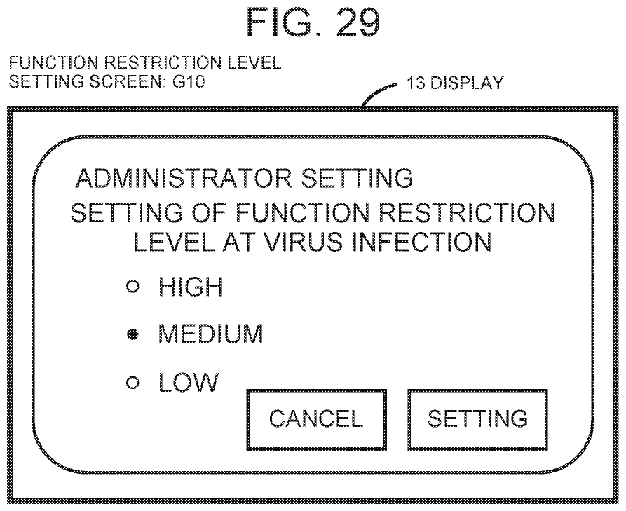

The restriction level can be set, for example, by displaying a function restriction level setting screen as shown in FIG. 29.

The administrator simply selects and enters one of the three restriction levels (high, medium, or low) displayed on the function restriction level setting screen.

Furthermore, although a description is made on assumption that a function restriction level is uniformly selected and entered as either high, medium, or low, regardless of a type of detected virus, the present disclosure is not limited to this and different function restriction levels may be set for the four different virus types described above.

For example, when a detected virus is a worm type, the restriction level may be set to “high” because of the possibility of spreading infection.
Furthermore, when a virus type of a detected virus is a macro type, the restriction level may be set to “low” since only a file operation is adversely affected.

The restriction level of the restriction level setting information 56 is set by the administrator, taking into consideration a location where the image-forming apparatus is installed and use states of the individual functions of the image-forming apparatus. For example, when the administrator desires to tighten the security of the image-forming apparatus and strictly restrict executable functions, the function restriction level is set to “high”.

Alternatively, when the number of image-forming apparatuses connected to the same network is small (for example, up to one or two image-forming apparatuses), or when a use state is such that a confirmation response by the administrator is rarely required, and when the operation rate of the image-forming apparatus is to be improved, the function restriction level may be set to “low”.

Example of Function Operation Availability Information 51

Specific examples of the function operation availability information 51 will be described with reference to FIGS. 2 to 9.
In the function operation availability information 51 shown in these drawings, information indicating whether execution of the individual seven functions (F01 to F07) of the image-forming apparatus is to be permitted or to be prohibited is set in advance.
Furthermore, after a virus is detected, different types of function operation availability information 51 are set for different states, such as a type and an infection location of the detected virus, and removal or no-removal of the virus.
Specifically, executable functions and prohibited functions are set in advance depending on a type of the detected virus, a virus removal state, and other factors.

The execution permission and the execution prohibition for the individual functions in the function operation availability information 51 shown in FIGS. 2 to 9 are merely examples and are not limited to the settings in this information.

For example, the administrator of the image-forming apparatus may change content of the function operation availability information 51, taking into account an installation location, a use state, a virus infection history, and other factors of the image-forming apparatus.

In the function operation availability information 51 in FIG. 2, the execution availability of the individual functions after a virus is detected and a type of the virus is identified but before the virus is removed are set.

Furthermore, it is assumed that the virus type is one of the four types described above (a macro type, a file type, a Trojan type, and a worm type), and the infection location is a network.
Examples of the case where the infection location is identified as a network include a case where a file attached to an e-mail received via a network is infected with a virus, and a case where an image file for printing purposes, a document file for storage purposes, or a configuration file that allows a configuration of a multifunction peripheral that are received via a network is infected with a virus.

In FIG. 2, the virus has not yet been removed, and therefore, executing the functions of the image-forming apparatus may cause problems in the operation of the image-forming apparatus or spread the virus.

Therefore, it is preferable to prohibit the execution of most of the functions of the image-forming apparatus.
However, as shown in FIG. 2, the copying function is not a function that performs communication processing through a network, but is a function that can operate even when the network is blocked and is a function completed only by the image-forming apparatus itself, and therefore, when the detected virus type is a macro type or a file type, the copying function may be permitted to be executed.
On the other hand, when a type of detected virus is a Trojan type or a worm type, execution of the copying function is prohibited because the infection may have spread to a memory or the like of the image-forming apparatus and the virus may further destroy the system. Furthermore, the functions F02 to F07 use a network and there is a possibility of infection spread, and therefore, execution of the functions is prohibited before the virus is removed, regardless of the type of detected virus.

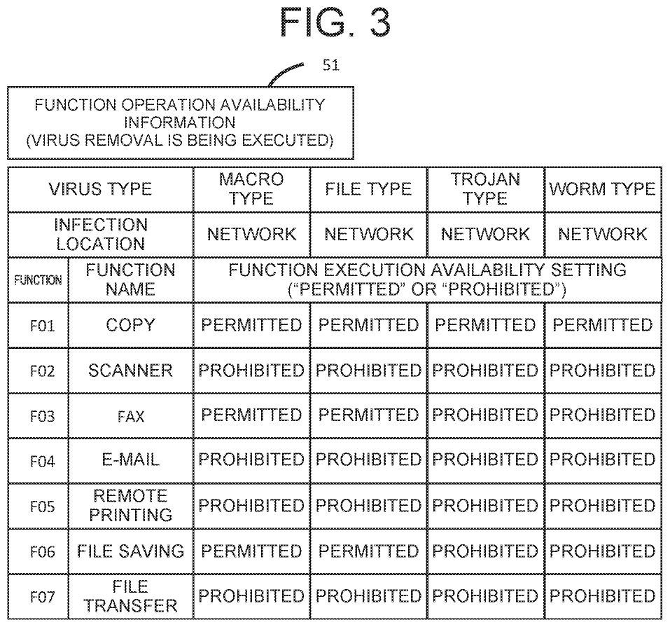

In the function operation availability information 51 in FIG. 3, the execution availability of the individual functions obtained after a type of the virus is identified, removal of the virus is started, and the removal is currently executed is set.

When the virus removal is in progress, the macro type and the file type are less likely to spread the virus than they were before virus removal because they are less likely to be secondarily infected by fax binary data or by internal storage alone, and therefore, of the functions that were prohibited from being executed, execution of the functions that are less likely to spread the virus, such as the fax function, may be permitted.
As shown in FIG. 3, for example, as for the copying function, the execution of the copying function is permitted even when the detected virus type is the Trojan type or the worm type, in addition to the macro type and the file type, because virus removal is available and the possibility of secondary infection is low.
Furthermore, as for the fax function and the file saving function, the execution of the functions is permitted when the detected virus type is the macro type or the file type, since the possibility of secondary infection is low.

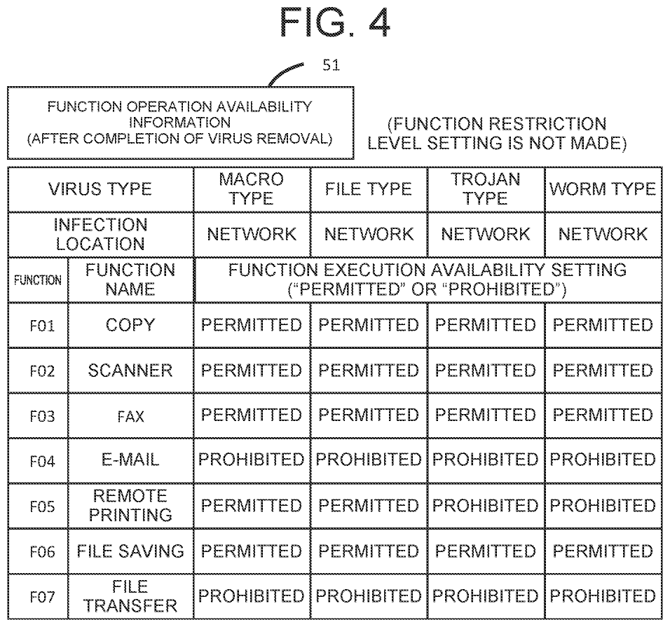

In the function operation availability information 51 in FIG. 4, the availability of the individual functions obtained after a virus is removed and before the administrator confirms the removal is set.

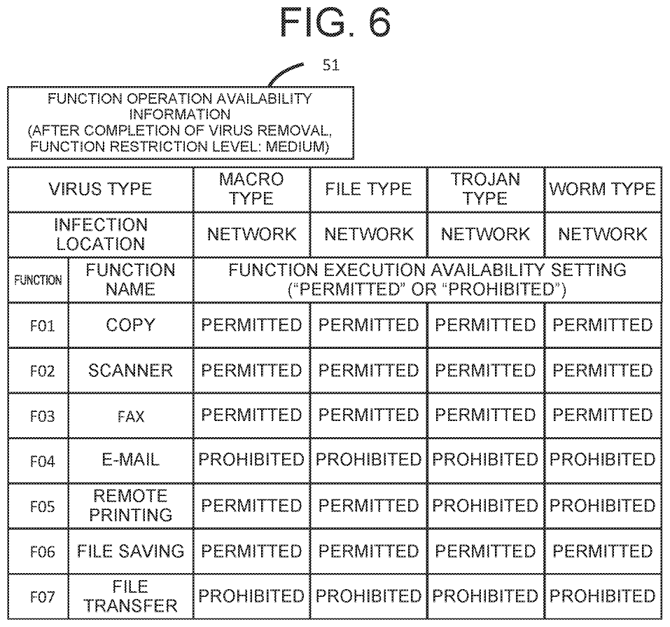

This is also a case of the example where the restriction level setting information 56 described above has not been set.
When the virus removal is completed, the possibility of influence of the virus is low and the secondary infection is extremely low because the virus is not operational, and therefore, it is less likely to cause problems in the image-forming apparatus or to spread the virus than before or during the virus removal.
Therefore, in principle, when the virus removal is completed, the restriction on all the functions may be lifted and execution of all the functions may be permitted.
Note that the function operation availability information 51 in FIG. 4 is the same as the information obtained when “medium” is set in the restriction level setting information shown in FIG. 6 described below, but is not limited to this.

However, in the function operation availability information 51 in FIG. 4, a number of the functions remain prohibited from being executed before the administrator confirms the removal in order to ensure a high level of security (safety).

Execution of all the functions is permitted only after the administrator performs a confirmation to determine there are no problems in executing the functions, such as actual confirmation of removal.
In the function operation availability information 51 in FIG. 4, the scanner function, the fax function, and the file saving function are permitted to be executed after the virus removal is completed, because the possibility that the virus spreads through the network is low and they are data generation functions that generate data inside the multifunction peripheral with the low possibility of infection, and therefore, the execution is permitted regardless of the type of virus.
Furthermore, a remote printing function is permitted when the detected virus is of the macro type or the file type and is prohibited when an externally executed instruction is of the Trojan type or the worm type that may be modified by the virus, since the remote printing function is externally operated.

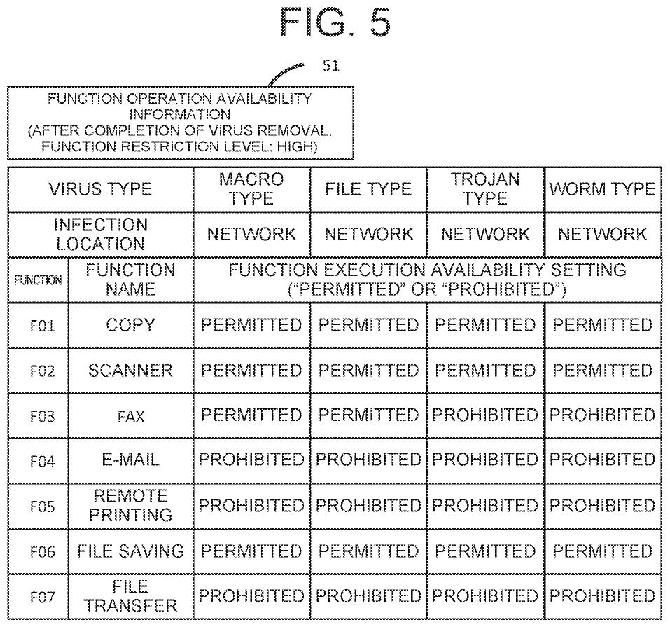

In the function operation availability information 51 in FIGS. 5, 6, and 7, the execution availability of the individual functions after virus removal is completed is set as in FIG. 4, and in addition, an example in which the restriction level setting information 56 described above is set is illustrated.

Since the virus removal is completed, the number of the prohibited functions is smaller than before or during the virus removal.

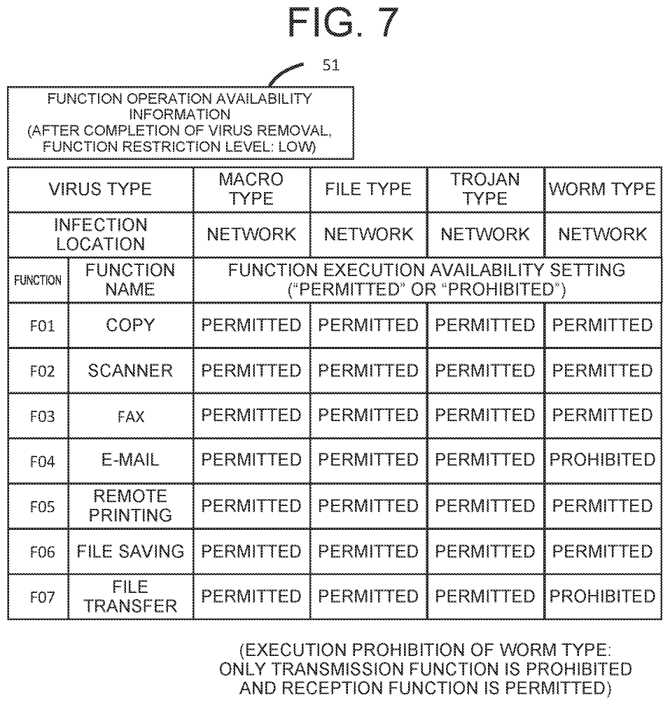

The function operation availability information 51 in FIG. 5 corresponds to a case where “high” is set in the restriction level setting information 56, the function operation availability information 51 in FIG. 6 corresponds to a case where “medium” is set in the restriction level setting information 56, and the function operation availability information 51 in FIG. 7 corresponds to a case where “low” is set in the restriction level setting information 56.

In the function operation availability information 51 in FIG. 5, the restriction level setting information 56 is set to “high”, and therefore, the security level is relatively high and a relatively larger number of the functions are prohibited from being executed.

In the function operation availability information 51 in FIG. 5, after the virus removal is completed, the scanner function and the file saving function are permitted to be executed, regardless of the type of the detected virus, because the functions correspond to an input system of a network.
Furthermore, the fax function is permitted to be executed, when the detected virus is the macro type or the file type since the fax function is binary data that is difficult to spread infection, and prohibited from being executed when the detected virus is the Trojan type or the worm type that may destroy the system and render the system inoperable.
On the other hand, the e-mail function, the remote printing, and the file transfer function are prohibited from being executed regardless of the type of the detected virus, since data is output to an outside through communication via the network.

In the function operation availability information 51 in FIG. 6, “medium” is set to the restriction level setting information 56, and therefore, the security level is lower than the security level of “high” and a relatively smaller number of functions are prohibited from being executed.

As described above, the settings of the function operation availability information 51 in FIG. 6 are the same as those in FIG. 4.

In the function operation availability information 51 in FIG. 7, the restriction level setting information 56 is set to “low”, and therefore, the security level is lowest among the security levels of “high”, “medium”, and “low”, and the number of prohibited functions is smallest.

In the function operation availability information 51 in FIG. 7, most of the functions are permitted, but when the detected virus is a worm type, only execution of functions of transmitting information through a network in the e-mail function and the file transfer function is prohibited in order to prevent the virus from spreading to reduce adverse effects of external data output.

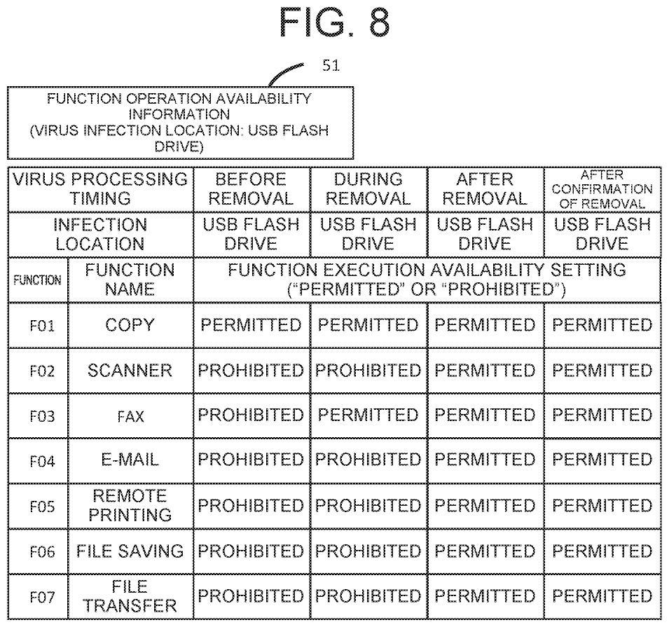

Although the function operation availability information 51 in FIGS. 2 to 7 is obtained when an infection location of a virus was identified as a network, the function operation availability information 51 in FIG. 8 is obtained when an infection location of a virus is identified as a USB flash device.

Furthermore, in FIG. 8, information in which execution availability of the individual functions is set is illustrated in four different virus processing timings.
The four virus processing timings correspond to a timing before virus removal, a timing during removal, a timing after removal, and a timing after the administrator confirms removal. Here, the USB flash drive is merely an example, and any so-called external storage medium that is temporarily connected to the image-forming apparatus may be detected, such as an SSD storage device and an external hard disk, in addition to the USB flash drive, as the infection location.

In the function operation availability information 51 in FIG. 8, for example, before the removal of the detected virus, only the copying function is executable, and the other functions (F02 to F07) are prohibited from being executed.

While the detected virus is being removed, only the copying and fax functions, which have a low possibility of infection, may be executed, and the other functions (F02, F04 to F07) are prohibited from being executed.
Furthermore, after the detected virus is removed and after the removal is confirmed by the administrator, all the functions, including those that have been prohibited from being executed, may be executed because the virus removal is completed only after infection from the USB flash drive and the possibility of secondary infection is low.

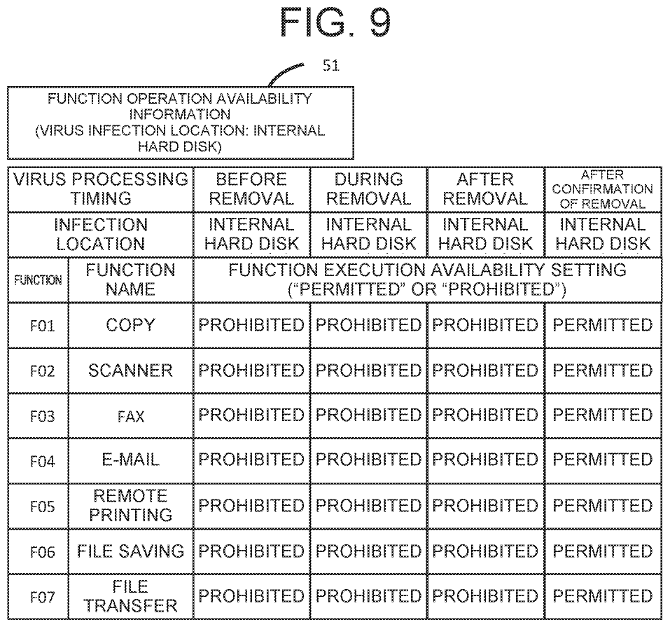

The function operation availability information 51 in FIG. 9 shows a case where a virus infection location is identified as an internal hard disk.

Furthermore, as in FIG. 8, information in which availability of the individual functions is set is illustrated in four different virus processing timings in FIG. 9.
Here, the internal hard disk is merely an example, and any so-called internal storage medium that is internally fixed in the image-forming apparatus may be identified, such as an internal SSD storage device, an SD card, or an eMMC, as the infection location.

In the function operation availability information 51 in FIG. 9, for example, before the removal of the detected virus, all the functions are prohibited since it is unknown whether the system is destroyed or operated.

In addition, the execution of all the functions is prohibited during the removal of a detected virus and also after a detected virus is removed but before confirmation of removal by the administrator, since all the functions use the internal hard disk.
However, after a detected virus is removed and the removal is confirmed by the administrator, it is considered that the administrator has confirmed that there are no adverse effects, such as system destruction, so all the functions are executable.

Examples of Virus Detection and Function Operation Control Process of Image-Forming Apparatus

### First Example

FIGS. 14 to 17 are flowcharts of an example of virus detection and a function operation control process of the image-forming apparatus.
It is assumed here that the function restriction level information 53 and the restriction level setting information 56 described above are not used, and the function operation availability information 51 in FIGS. 5 to 7 is not used after virus removal is completed, and the function operation availability information 51 in FIG. 4 is used.

In step S1 of FIG. 14, the virus detector 20 performs virus detection check. When a virus is detected in step S2, the process proceeds to step S3, and otherwise, the process returns to step S1.

In step S3, all the functions of the image-forming apparatus are stopped.

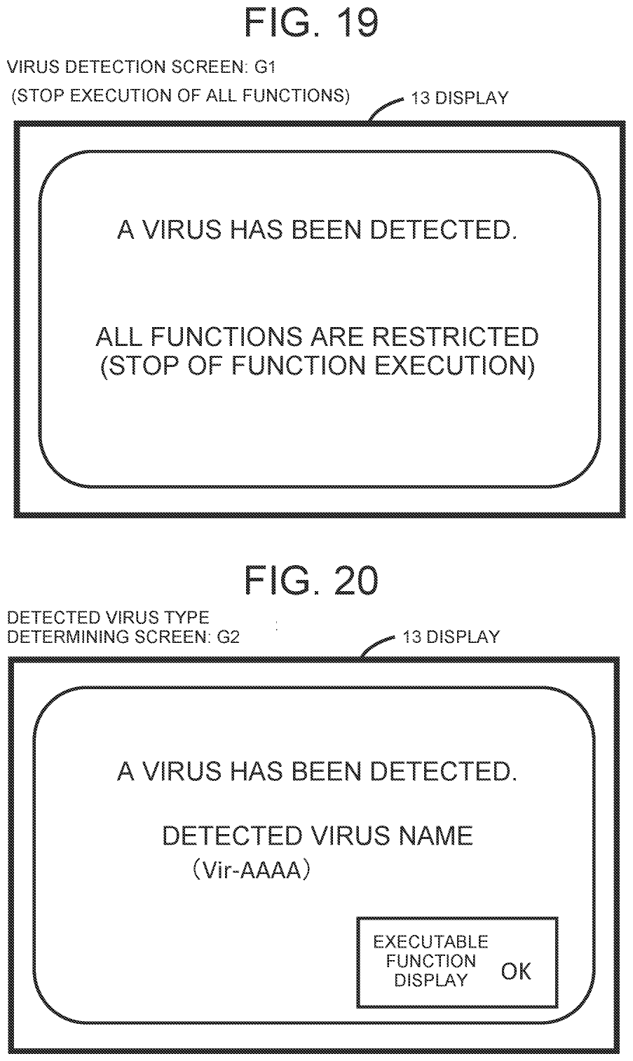

Furthermore, the execution prohibition (“prohibited”) is set to the execution availability for all the functions in the function execution setting information 55.
In step S4, the screen display controller 27 displays a screen (a virus detection screen: G1, FIG. 19) indicating that a virus has been detected and that all the functions of the image-forming apparatus have been stopped on the display 13.
For example, information “A virus has been detected. All the functions are restricted” is displayed as illustrated in FIG. 19.

In step S5, the virus type determiner 22 determines a virus name and a virus type of the detected virus.

Here, for example, the virus management information 52 described above is used to acquire a name and a type of a known virus corresponding to the detected virus.
The acquired virus names and the acquired virus types are stored in the detected virus information 54.
In step S6, the screen display controller 27 displays a screen (a detected virus type determination screen: G2, FIG. 20) indicating the virus name and the virus type of the detected virus on the display 13.
For example, as shown in FIG. 20, the “detected virus name” is displayed, and in addition, a selection item region indicated by “executable function display: OK”, for example, is displayed to display currently executable functions.

In step S7, the infection location identifier 23 acquires an infection location. Furthermore, the acquired infection location is stored in the detected virus information 54. In step S8, the function execution availability determiner 25 reads the function operation availability information 51.

Here, since the virus has not been removed, the function operation availability information 51 corresponding to “after virus type identification and before removal” is read, as shown in FIG. 2 above, when the infection location is a network.
Furthermore, when the infection location is other than a network, for example, a USB flash drive or an internal hard disk, the function operation availability information 51 in FIG. 8 or FIG. 9 is read.

In step S9, the function execution availability determiner 25 determines whether each of the functions may be executed using the function operation availability information 51 and the detected virus information 54.

Here, a “function execution availability setting” set in the function operation availability information 51 in accordance with the virus type and the infection location stored in the detected virus information 54 is used to determine the execution availability.
In step S10, the function operation setter 26 stores a result of the determination of the function execution availability in the function execution setting information 55.
Specifically, the execution availability (execution permission or execution prohibition) is set for each of all the functions of the image-forming apparatus.

In step S11, suspension of the functions set as execution permission in the function execution setting information 55 is released.

Specifically, among the functions stopped to be executed in step S3, the functions that are set to be execution permission are set to be available for execution.
In step S12, with the screen G2 currently displayed, it is determined whether a user who intends to use the image-forming apparatus has performed an input, and when the determination is negative, the process in step S12 is repeatedly performed.
On the other hand, when the user selects and inputs the region indicated by “executable function display: OK” while the screen G2 is displayed, the process proceeds to step S13.

In step S13, the screen display controller 27 displays the function selection screen on the display 13 using the function execution setting information 55.

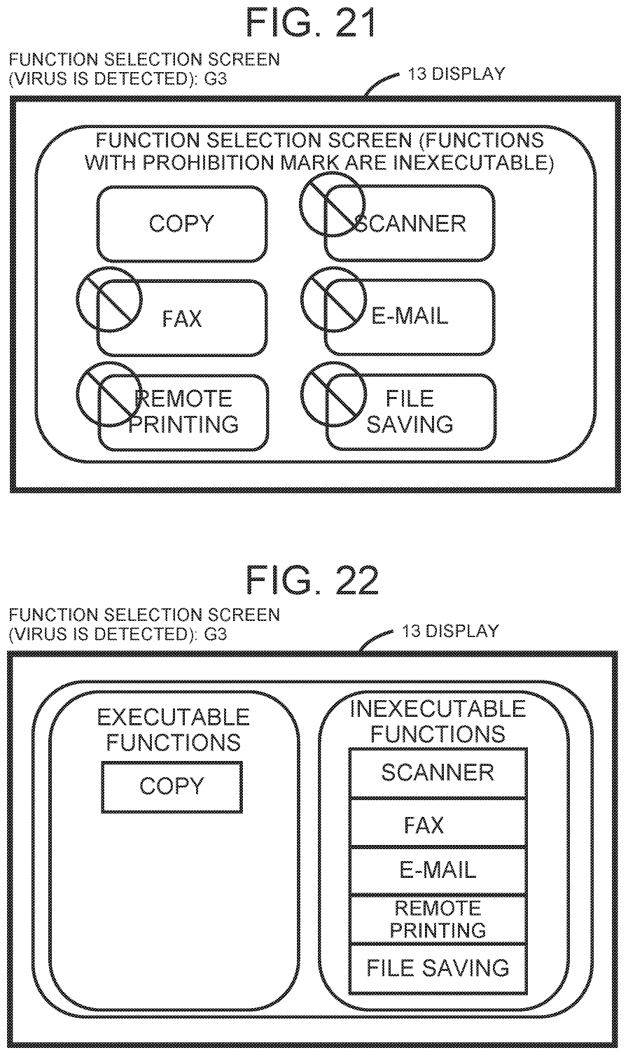

Here, the executable functions and the prohibited functions are displayed on the function selection screen in a distinguishable manner.
For example, when the function operation availability information 51 in FIG. 2 is read, the detected virus is a macro type, and the infection location is a network, only the copying function is permitted to be executed and the other functions are prohibited, and therefore, the function selection screen G3 is displayed at the time of virus detection as shown in FIG. 21.

In FIG. 21, although selection display regions of the six functions are displayed in the function selection screen G3, functions with a predetermined prohibition mark that implies prohibition of execution and that is superposed on the selection display regions indicate functions that may not be executed.

Specifically, in FIG. 21, only the copying function is selectable and the other functions including the scanner function are not selectable since the prohibition mark is displayed on the superposed manner.
Alternatively, even when the user performs an input operation to select one of the selection display regions for the other functions, such as the scanner function, the selection input operation is ignored.

As shown in FIG. 22, the function selection screen may be displayed in a state in which the executable functions and the prohibited functions are distinguished from each other. Note that the function selection screens in FIGS. 21 and 22 displays the six functions, and the file transfer function (F07) is omitted, but the file transfer function may also be displayed.

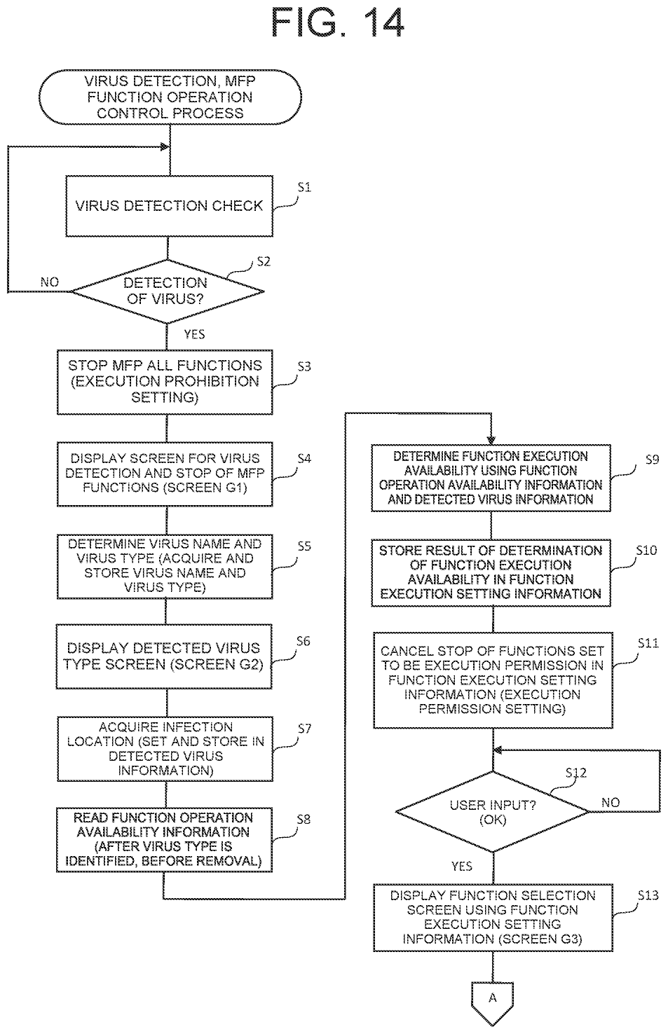

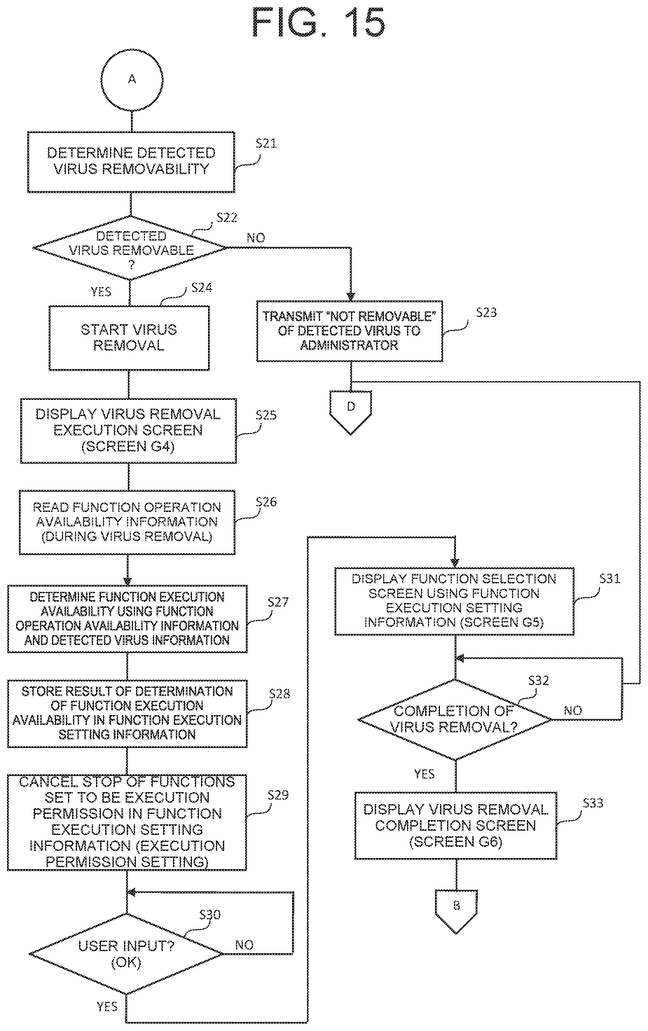

After step S13, the process proceeds to step S21 of FIG. 15.

In step S21, it is determined whether the detected virus is removable.
For example, when the removability is set in advance in the virus management information 52 shown in FIG. 10 described above, the virus management information 52 is used to determine whether removal may be performed.
When the detected virus is removable in step S22, the process proceeds to step S24, and otherwise, the process proceeds to step S23.

In step S23, since the detected virus is not removable, information indicating that the detected virus is not removable is transmitted to the administrator of the image-forming apparatus.

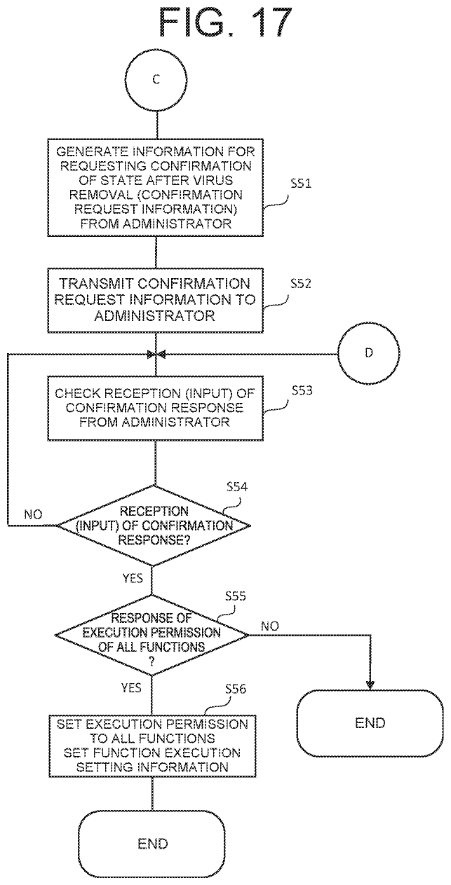

In this case, the administrator of the image-forming apparatus is required to take countermeasures against the virus that is not removable.
After step S23, the process may proceed to step S53 in FIG. 17 or may be terminated without waiting for a response of confirmation from the administrator.

In step S24, the virus remover 24 starts removal of the virus since it is determined that the detected virus is removable.

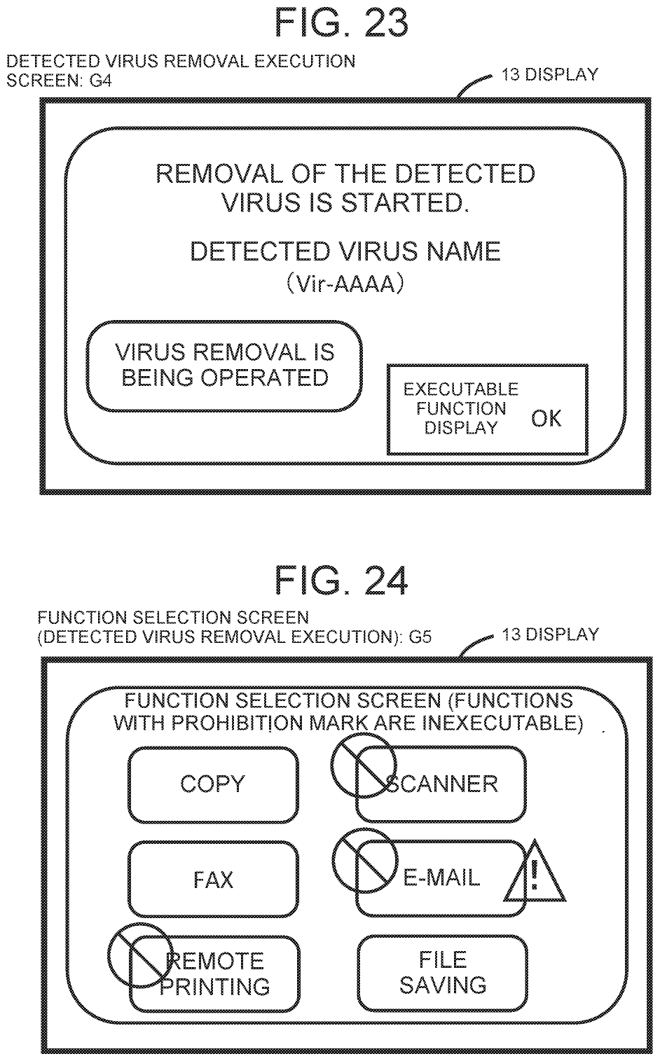

In step S25, the screen display controller 27 displays a screen (a detected virus removal execution screen: G4, FIG. 23) indicating that removal of the detected virus is being executed on the display 13.
For example, as shown in FIG. 23, a messages, such as “Removal of the detected virus is started” and “Virus removal is being operated”, are displayed, and in addition, the selection item region represented as “executable function display: OK” is displayed to display currently executable functions.

In step S26, as in step S8, the function execution availability determiner 25 reads the function operation availability information 51.

Here, since the virus is being removed, the function operation availability information 51 corresponding to “Virus removal is being executed” is read, as shown in FIG. 3 above, when the infection location is a network.
Furthermore, when the infection location is other than a network, for example, a USB flash drive or an internal hard disk, the function operation availability information 51 in FIG. 8 or FIG. 9 is read.

In step S27, as in step S9, the function execution availability determiner 25 determines whether each of the functions is executable using the function operation availability information 51 and the detected virus information 54.

Here, the “function execution availability setting” set in the function operation availability information 51 in accordance with the virus type and the infection location stored in the detected virus information 54 is used to determine the execution availability.

In step S28, as in step S10, the function operation setter 26 stores a result of the determination of the function execution availability in the function execution setting information 55.

Specifically, the execution availability (execution permission or execution prohibition) is set for each of all the functions of the image-forming apparatus.

In step S29, as in step S11, suspension of the functions set as execution permission in the function execution setting information 55 is released.

Specifically, among the functions stopped to be executed in step S3, the functions that are set to be execution permission are set to be available for execution.
In step S30, with the screen G4 currently displayed, it is determined whether the user who intends to use the image-forming apparatus has performed an input, and when the determination is negative, the process in step S30 is repeatedly performed.
On the other hand, when the user selects and inputs the region indicated by “executable function display: OK” while the screen G4 is displayed, the process proceeds to step S31.

In step S31, the screen display controller 27 displays a function selection screen (a detected virus removal execution: G5, FIG. 24) on the display 13 using the function execution setting information 55.

Here, as in FIG. 21, the executable functions and the prohibited functions are displayed on the function selection screen in a distinguishable manner.
For example, when the function operation availability information 51 in FIG. 3 is read, the detected virus is a file type, and the infection location is a network, the copying function, the fax function, and the file saving function are permitted to be executed and the other functions (the scanner function, the e-mail function, and the remote printing function) are prohibited, and therefore, the function selection screen G5 is displayed at the time of virus removal as shown in FIG. 24.

In the function selection screen G5 in FIG. 24, the case where the infection location is identified as a file attached to a received e-mail is shown, and in order to clearly indicate that the e-mail is the infection location (infection source), an infection source mark indicating the infection location is displayed on the selection display region of “e-mail”.

In FIG. 24, a mark “!” is displayed as the infection source mark, but the infection source mark is not limited to this, and any mark that is different from the prohibition mark may be used, and a symbol or a character indicating the infection location may be displayed.
Such an infection source mark indicating the infection location is preferably displayed to inform the user of the infection location, but the infection source mark may not be displayed or the administrator may set availability of display of the infection source mark.

When the removal of the virus is completed by the virus remover 24, the process proceeds to step S33, and otherwise, the process proceeds to step S32.

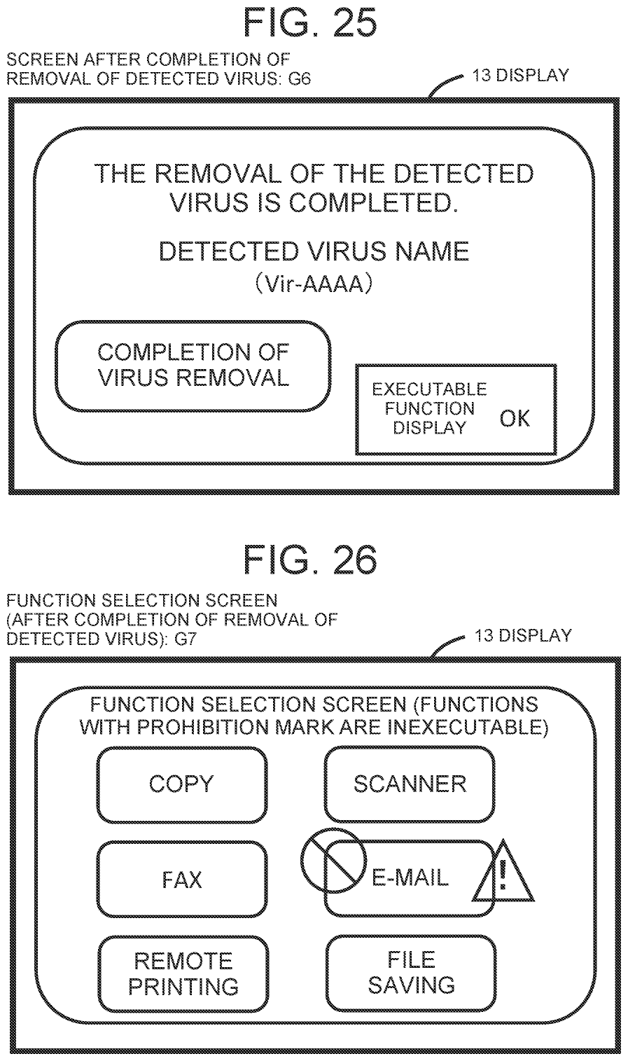

In step S33, the screen display controller 27 displays a screen (screen after completion of removal of detected virus: G6, FIG. 25) indicating that the removal of the detected virus is completed on the display 13.
For example, as shown in FIG. 25, messages, such as “The removal of the detected virus is completed” and “Completion of virus removal”, are displayed, and in addition, the selection item region represented as “executable function display: OK” is displayed to display currently executable functions.

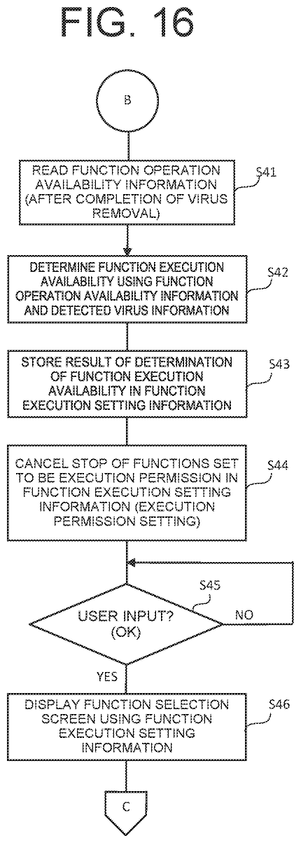

After step S33, the process proceeds to step S41 of FIG. 16.

In step S41 of FIG. 16, as in step S8, the function execution availability determiner 25 reads the function operation availability information 51.
Here, since the removal of the virus is completed, the function operation availability information 51 corresponding to “After completion of virus removal” is read, as shown in FIG. 4 above, when the infection location is a network.
Furthermore, when the infection location is other than a network, for example, a USB flash drive or an internal hard disk, the function operation availability information 51 in FIG. 8 or FIG. 9 is read.

In step S42, as in step S9, the function execution availability determiner 25 determines whether each of the functions is executable using the function operation availability information 51 and the detected virus information 54.

Here, a “function execution availability setting” set in the function operation availability information 51 in accordance with the virus type and the infection location stored in the detected virus information 54 is used to determine the execution availability.

In step S43, as in step S10, the function operation setter 26 stores a result of the determination of the function execution availability in the function execution setting information 55.

Specifically, the execution availability (execution permission or execution prohibition) is set for each of all the functions of the image-forming apparatus.

In step S44, as in step S11, suspension of the functions set as execution permission in the function execution setting information 55 is released.

Specifically, among the functions stopped to be executed in step S3, the functions that are set to be execution permission are set to be available for execution.
In step S45, with the screen G6 currently displayed, it is determined whether the user who intends to use the image-forming apparatus has performed an input, and when the determination is negative, the process in step S45 is repeatedly performed.
On the other hand, when the user selects and inputs the region indicated by “executable function display: OK” while the screen G6 is displayed, the process proceeds to step S46.

In step S46, the screen display controller 27 displays a function selection screen (a screen after completion of removal of a detected virus: G7, FIG. 26) on the display 13 using the function execution setting information 55.

Here, as in FIG. 21, the executable functions and the prohibited functions are displayed on the function selection screen in a distinguishable manner.
For example, when the function operation availability information 51 in FIG. 4 is read, the detected virus is a macro type, and the infection location is a network, the copying function, the scanner function, the fax function, the remote printing function, and the file saving function are permitted to be executed and the e-mail function is prohibited, and therefore, the function selection screen G7 is displayed at the time of virus detection as shown in FIG. 26. In the function selection screen G7 in FIG. 26, the prohibition mark is superposed on the selection display region represented as “e-mail” where execution is prohibited. Furthermore, in the function selection screen G7 in FIG. 26, the infection source mark indicating the infection location is also superposed on the selection display region represented as “e-mail” that is the infection location.

After step S46, the process proceeds to step S51 of FIG. 17.

In step S51 of FIG. 17, the confirmation requester 30 generates information (confirmation request information) requesting the administrator of the image-forming apparatus to confirm a state after the virus removal.
The confirmation request information includes, for example, a name (a product number) of the image-forming apparatus, an installation location of the image-forming apparatus, a name of the detected virus, a virus type, an infection location, a time of infection, completion of removal, requirement of confirmation after the removal, and a list of various setting data of the multifunction peripheral.
In step S52, the confirmation requester 30 transmits the generated confirmation request information to the mobile terminal or other device of the administrator.

In step S53, it is determined whether a response of confirmation transmitted from the mobile terminal or other device of the administrator is received.

Alternatively, the administrator may come to the installation location of the image-forming apparatus and actually check a state of the image-forming apparatus after the virus removal, and thereafter, when it is confirmed that a problem caused by the detected virus has been resolved and normal operation is available, the administrator may perform a predetermined input operation for the confirmation response.
In this case, it may be determined whether a confirmation response has been input by the administrator.

In step S54, the process proceeds to step S55 when the confirmation response has been received or input, and otherwise, the process returns to step S53.

In step S55, when the received confirmation response indicates permission of execution of all the functions, the process proceeds to step S56, and otherwise, the process is terminated. Alternatively, also when the confirmation response input by the administrator indicates permission of execution of all the functions, the process proceeds to step S56.

In step S56, all the functions of the image-forming apparatus are set to be execution permission, and the process is terminated.

Specifically, “execution permission” is set to the availability of all the functions in the function execution setting information 55.
Furthermore, when the function selection screen is displayed after all the functions of the image-forming apparatus are set to be “execution permission”, a screen with no prohibition marks is displayed on the selection display regions for all the functions.

As described above, when a virus is detected, a type of the detected virus and an infection location are used to set executable functions and prohibited functions according to a state of virus detection and removal, etc., and therefore, a situation in which all the functions may not be used until the virus is removed may be avoided while spread of virus infection is suppressed.

Furthermore, even after infection with a virus and before removal is completed, functions that do not expand operation or infection of the image-forming apparatus are set to be executable, and therefore, the decline in the operation rate of the image-forming apparatus is suppressed and usability of the executable functions for users who use the image-forming apparatus may be ensured.

### Second Example

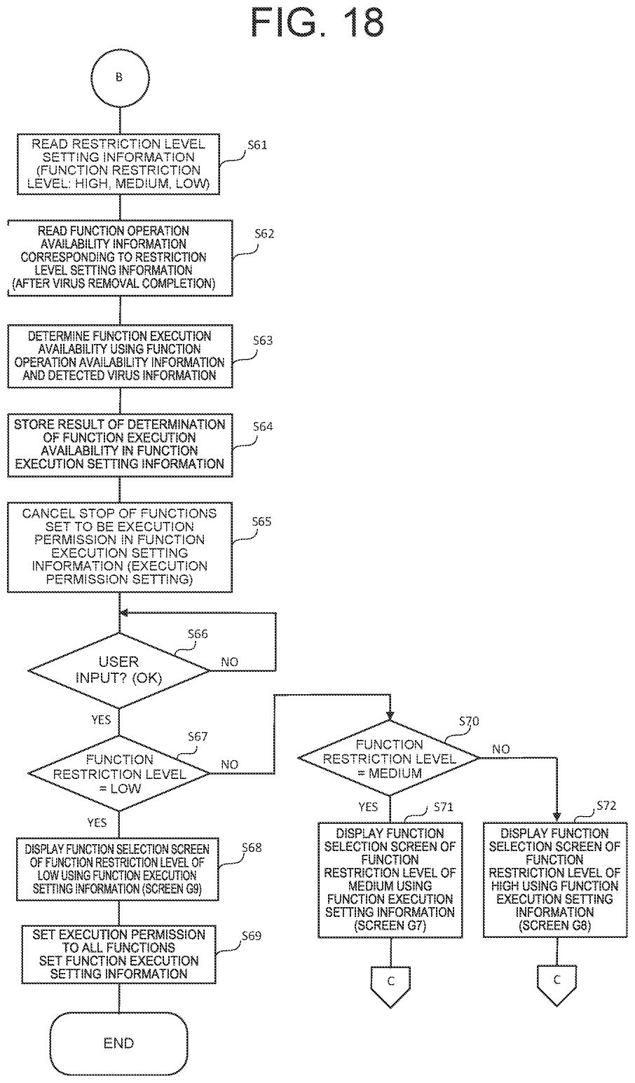

FIG. 18 is a flowchart of an example of virus detection and a function operation control process of the image-forming apparatus.
It is assumed here that the function restriction level information 53 and the restriction level setting information 56 described above are used, and the function operation availability information 51 in FIGS. 5 to 7 is used after virus removal is completed.
Furthermore, it is assumed that, when the restriction level setting information 56 is “high” or “medium,” as in the function restriction level information 53 shown in FIG. 11, confirmation of the administrator is required before permission of execution of all the functions after the virus is removed.
On the other hand, when the restriction level setting information 56 is “low”, after the virus is removed, no confirmation by the administrator is required and all the functions are permitted to be executed.

It is assumed, also in this example, that as in the first example above, the same process as in the flowcharts shown in FIGS. 14 and 15 is performed, and after step S33 in FIG. 15, the process proceeds to step S61 in FIG. 18, instead of FIG. 16.

Hereinafter, a description of the process from step S1 to step S33, which is the same as in the first example, is omitted, and a process from step S61 in FIG. 18 onward will be described.

In step S61 of FIG. 18, the restriction level setting information 56 stored in the storage 50 is read.

It is assumed that the restriction level setting information 56 is “high”, “medium”, or “low”.

In step S62, the function operation availability information 51 corresponding to the read restriction level setting information 56 is read.

Here, the function operation availability information 51 is obtained after virus removal is completed, and for example, the function operation availability information 51 in FIG. 5, 6 or 7 that corresponds to the restriction level setting information 56 is used.
That is, when the restriction level setting information 56 is “high”, the function operation availability information 51 in FIG. 5 is read, when the restriction level setting information 56 is “medium”, the function operation availability information 51 in FIG. 6 is read, and when the restriction level setting information 56 is “low”, the function operation availability information 51 in FIG. 7 is read.

In step S63, as in step S9, the function execution availability determiner 25 determines whether each of the functions is executable using the function operation availability information 51 and the detected virus information 54.

Here, a “function execution availability setting” set in the function operation availability information 51 in accordance with the virus type and the infection location stored in the detected virus information 54 is used to determine the execution availability.

In step S64, as in step S10, the function operation setter 26 stores a result of the determination of the function execution availability in the function execution setting information 55.

Specifically, the execution availability (execution permission or execution prohibition) is set for each of all the functions of the image-forming apparatus.

In step S65, as in step S11, suspension of the functions set as execution permission in the function execution setting information 55 is released.

Specifically, among the functions stopped to be executed in step S3, the functions that are set to be execution permission are set to be available for execution.

In step S66, with the screen G6 currently displayed, it is determined whether the user who intends to use the image-forming apparatus has performed an input, and when the determination is negative, the process in step S66 is repeatedly performed.

On the other hand, when the user selects and inputs the region indicated by “executable function display: OK” while the screen G6 is displayed, the process proceeds to step S67.

When content of the function restriction level in the read restriction level setting information 56 is “low” in step S67, the process proceeds to step S68, and otherwise, the process proceeds to step S70.

When content of the function restriction level in the read restriction level setting information 56 is “medium” in step S70, the process proceeds to step S71, and otherwise, the process proceeds to step S72.
When the content of the function restriction level is “high”, the process proceeds to step S72.

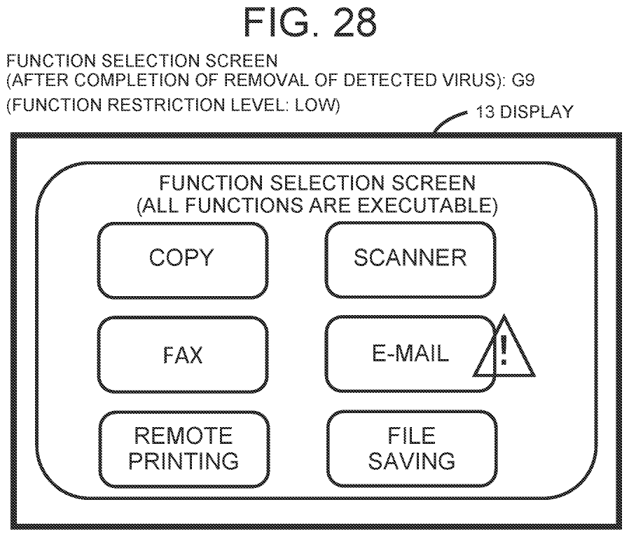

In step S68, the screen display controller 27 displays a function selection screen (a screen after completion of removal of a detected virus, and a low function restriction level: G9, FIG. 28) on the display 13 using the function execution setting information 55.

It is assumed here that, since the function restriction level is “low”, confirmation performed by the administrator is not required and execution of all the functions is permitted, as shown in FIG. 28, the selection display regions of all the functions are displayed in a selectable state. In other words, the prohibition mark is not displayed for all the functions.
Furthermore, also in the function selection screen G9 in FIG. 28, the infection source mark indicating the infection location is superposed on the selection display region of “e-mail” that is the infection location.

After step S68, as in step S56, all the functions of the image-forming apparatus are set to be execution permission in step S69, and the process is terminated.

Specifically, “execution permission” is set to the availability of all the functions in the function execution setting information 55.

In step S71, the screen display controller 27 displays the function selection screen (a screen after completion of removal of a detected virus, and a medium function restriction level: G7, FIG. 26) to be displayed when the function restriction level is “middle” on the display 13 using the function execution setting information 55, and thereafter, the process proceeds to step S51 of FIG. 17.

Here, although the screen is the same as the function selection screen displayed in step S46 of FIG. 16 above, a different screen may be displayed.
As has been described, in the function selection screen G7 in FIG. 26, the prohibition mark is displayed in a superposed manner on the selection display region of “e-mail” where execution is prohibited, but the selection display regions of the copying function, the scanner function, the fax function, the remote printing function, and the file saving function, where execution is permitted, are displayed in a selectable state.

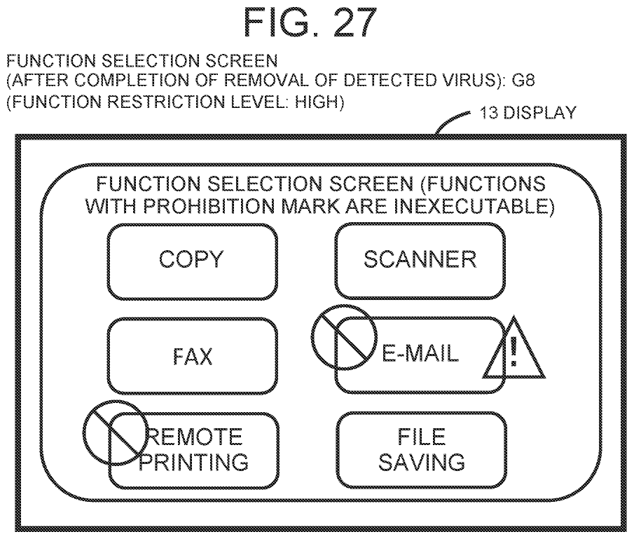

In step S72, the screen display controller 27 displays the function selection screen (a screen after completion of removal of a detected virus, and a high function restriction level: G8, FIG. 27) to be displayed when the function restriction level is “high” on the display 13 using the function execution setting information 55, and thereafter, the process proceeds to step S51 of FIG. 17.

Also in this function selection screen, as in FIG. 21, the executable functions and the prohibited functions are displayed in a distinguishable manner.

For example, when the function operation availability information 51 in FIG. 5 corresponding to the function restriction level of “high” is read, the detected virus is a macro type, and the infection location is a network, the copying function, the scanner function, the fax function, and the file saving function are permitted to be executed and the e-mail function and the remote printing function are prohibited, and therefore, the function selection screen G8 after the virus detection is completed is displayed as shown in FIG. 27.

In the function selection screen G8 in FIG. 27, the prohibition mark is displayed on the selection display regions of “e-mail” and “remote printing function” where execution is prohibited.
Furthermore, also in the function selection screen G8 in FIG. 27, the infection source mark indicating the infection location is superposed on the selection display region represented as “e-mail” that is the infection location.

As described above, also in the second example, as in the first example, when a virus is detected, a type of the detected virus and an infection location are used to set executable functions and prohibited functions according to a state of virus detection and removal, etc., and therefore, a situation in which all the functions may not be used until the virus is removed may be avoided while spread of virus infection is suppressed.

Furthermore, since the function operation availability information 51 corresponding to the function restriction level set in advance is used, and the confirmation response is not requested to the administrator as in the case of the function restriction level of “low” described above instead of the case where the confirmation response is always requested to the administrator, decrease in the operation rate of the image-forming apparatus after virus removal is completed is suppressed, and the usability of the executable functions for users of the image-forming apparatus can be ensured.

What is claimed is:

1. An information processing apparatus comprising:
a virus detector that detects a computer virus;
a virus information acquirer that acquires virus information that identifies the detected computer virus;
a function execution availability determiner that determines functions to be permitted and functions to be prohibited using the acquired virus information;
a function operation setter that sets execution availability of the functions based on a result of the determination made by the function execution availability determiner; and
a function executer that executes a selected one of the functions, wherein
the function operation setter sets functions determined to be permitted as execution permitted functions and functions determined to be prohibited as execution prohibited functions, and
the functions set as the execution prohibited functions by the function operation setter are prohibited from being executed by the function executer until a state in which execution is to be permitted is entered and become executable by the function executer after the state in which execution is to be permitted is entered.

2. The information processing apparatus according to claim 1, further comprising:
a virus remover that removes the detected computer virus, wherein
the functions to be permitted and the functions to be prohibited that are determined by the function execution availability determiner differ between before and after removal of the detected computer virus, and
the number of functions to be permitted after the removal of the detected computer virus is larger than the number of functions to be permitted before the removal.

3. The information processing apparatus according to claim 1, further comprising:
a virus remover that removes the detected computer virus, wherein
the state in which execution is to be permitted is entered after the virus remover removes the detected computer virus.

4. The information processing apparatus according to claim 1, further comprising:
a virus remover that removes the detected computer virus; and
a confirmation requester that requests confirmation that adverse effects of the removed computer virus are negligible from an administrator after the virus remover removes the detected computer virus, wherein
the state in which execution is to be permitted is entered after the administrator confirms that adverse effects of the removed computer virus are negligible.

5. The information processing apparatus according to claim 1, wherein
the virus information acquirer includes
a virus type determiner that determines a type of the detected computer virus, and
an infection location identifier that identifies a location infected with the detected computer virus, and
the acquired virus information includes a type and the infection location of the detected computer virus.

6. The information processing apparatus according to claim 1, further comprising:
a storage that stores in advance function operation availability information including execution availability of the individual functions associated with types of computer virus and infection locations of the computer viruses, wherein
the function execution availability determiner determines, using the function operation availability information, whether each of the functions is to be permitted or prohibited according to function execution availability associated with a type of the detected computer virus and a location infected with the detected computer virus.

7. The information processing apparatus according to claim 1, further comprising:
a display that displays a function selection screen including different selection display regions for different functions; and
an operation acceptor that performs an input operation to select one of the selection display regions corresponding to a desired function, so as to execute the desired function, wherein
at least one of the selection display regions of a function set as an execution prohibited function by the function operation setter is displayed on the function selection screen such that the selection display region is not selectable by the operation acceptor.

8. The information processing apparatus according to claim 1, wherein the information processing apparatus is an image-forming apparatus having a plurality of functions.

9. A function operation control method of an information processing apparatus including a controller, the controller executes:
detecting a computer virus;
acquiring virus information that identifies the detected computer virus;
determining functions to be permitted and functions to be prohibited using the acquired virus information; and
setting execution availability of the functions based on a result of the determination such that functions determined to be permitted as execution permitted functions and functions determined to be prohibited as execution prohibited functions, wherein
the functions set as the execution prohibited functions are prohibited until a state in which execution is to be permitted is entered and become executable after the state in which execution is to be permitted is entered.

10. The function operation control method of an information processing apparatus according to claim 9, wherein
the acquiring virus information includes
determining a type of the detected computer virus, and
identifying a location infected with the detected computer virus,
the acquired virus information includes the type and the infection location of the detected computer virus, and
in the determining functions to be permitted and functions to be prohibited, it is determined, using function operation availability information in which execution availability of the individual functions are set in advance such that the execution availability is associated with a type of the detected computer virus and a location infected with the detected computer virus, whether each of the functions is to be permitted or to be prohibited in accordance with function execution availability associated with a type of the detected computer virus and a location infected with the detected computer virus.
